(19) United States
(12) Patent Application Publication
(10) Pub. No.: US 2013/0062285 A1
(43) Pub. Date: Mar. 14, 2013

(54) Oil-Tolerant Polymer Membranes for Oil-Water Separations

(71) Applicants: Eric M.V. Hoek, Los Angeles, CA (US); Fubing Peng, Shanghai (CN); Jinwen Wang, Los Angeles, CA (US)

(72) Inventors: Eric M.V. Hoek, Los Angeles, CA (US); Fubing Peng, Shanghai (CN); Jinwen Wang, Los Angeles, CA (US)

(73) Assignee: The Regents of the University of California, Oakland, CA (US)

(21) Appl. No.: 13/697,277

(22) PCT Filed: May 11, 2011
(86) PCT No.: PCT/US11/36154

§ 371 Date: Nov. 9, 2012

Related U.S. Application Data
(60) Provisional application No. 61/333,736, filed on May 11, 2010.

(51) Int. Cl. B01D 71/68; B01D 69/12; C02F 1/44; B01D 71/00; B01D 71/06

(52) U.S. Cl. CPC B01D 71/68; B01D 71/00; B01D 71/06; C02F 1/44; B01D 69/125
USPC 210/650; 210/500.21; 210/500.41; 210/500.42; 427/243

(57) ABSTRACT

The invention relates to oil-tolerant water-filtration membranes comprising a microporous hydrogel coated on a porous polymeric support membrane, useful in separating hydrocarbons and hydrocarbon emulsions from a water sample. The oil-tolerant water-filtration membranes comprising a hydrophilic microporous crosslinked polymeric hydrogel coated on at least one side of a porous polymeric support membrane. The water-filtration membrane having a first face corresponding to the discrimination layer and a second face corresponding to the porous support, applying pressure to a water solution, having at least one solute, at the first face of the water-filtration membrane, and collecting purified water at the second face of water-filtration membrane. Polymeric membranes have many advantages over ceramics, including inexpensive manufacture and the ability to be manufactured into very compact (high surface area) elements.

### CROSS-REFERENCE TO RELATED APPLICATIONS

This application claims the benefit of U.S. Application No. 61/333,736, filed May 11, 2010, which is hereby incorporated herein by reference in its entirety.

### BACKGROUND

There exists a need for efficient removal of hydrocarbons, in particular complex mixtures of hydrocarbons such as oil, from water. Large-scale methods for removal of oil from water range from giant containment booms and absorbent skimmers to controlled fires and chemical dispersants with questionable effects on human health and the environment. Filtration methods could provide a more efficient and scalable approach to removing oil from water. In the past, ceramic membranes have been used in the industry because traditional polymeric materials are not oil-tolerant. Although ceramic membranes are oil-tolerant, they have significant disadvantages in application to removing oil from large volumes of contaminated water. These include their high weight and the considerable production costs of ceramic components. Polymeric membranes have many advantages, but in particular they are cheaper to manufacture and can be made into very compact elements with a high surface area which greatly reduces the plant size and cost relative to ceramic membranes.

Conventional poly(vinyl alcohol) (“PVA”) membranes are attractive for water treatment processes due to their excellent thermal, mechanical and chemical stability, as well as their low fouling interface. These properties make them an attractive polymer for water treatment processes. However, conventional PVA membranes have not produced competitive water permeabilities due to the semi-crystalline nature of such membranes which results from strong hydrogen bonding interactions. The inherent hydrophilicity of conventional PVA membranes leads to high water uptake and swelling in water. A solution to the this problem is to crosslink the PVA in order to increase stability and to produce adequate selectivity in molecular separations. While there have been many previous attempts to develop cross-linked PVA membranes, none of these past formulations achieved commercial success because the membranes exhibited relatively low permeability and selectivity due to defect formation, improper cross-linking, or excessive thickness of PVA coating layers.

Therefore, there remains a need for methods and compositions that overcome these deficiencies and that effectively provide for oil-tolerant polymeric membranes that can enable large-scale oil-water separations with significant removal of hydrocarbons.

### SUMMARY

In accordance with the purpose(s) of the invention, as embodied and broadly described herein, the invention relates to oil-tolerant polymeric water-filtration membranes, preparation thereof, and uses thereof. As described herein, polymeric membranes have many advantages over ceramics, including inexpensive manufacture and the ability to be manufactured into very compact (high surface area) elements.

More specifically, described herein are oil-tolerant water-filtration membranes comprising a microporous hydrogel coated on at least one side of a porous polymeric support membrane. The membranes described herein can be used to separate hydrocarbons and hydrocarbon emulsions from a water sample without salt rejection.

In one aspect, described herein are oil-tolerant water-filtration membranes comprising a crosslinked poly(vinyl alcohol) film coated on at least one side of a polysulfone support membrane. In a further aspect, the poly(vinyl alcohol) film coating can be stabilized via crosslinking through the utilization of a variety of crosslinking agents, including, but not limited to, succinic acid, maleic acid, malic acid, glutaraldehyde, or suberic acid.

Also described herein are methods for preparing oil-tolerant water-filtration membranes comprising applying a porous hydrophilic crosslinked polymeric coating to at least one side of a porous polymeric support membrane.

Further described herein are methods for water-filtration comprising providing a water-filtration membrane comprising a microporous hydrogel coated on a porous polymeric support membrane, the water-filtration membrane having a first face corresponding to the discrimination layer and a second face corresponding to the porous support, applying pressure to a water solution, having at least one solute, at the first face of the water-filtration membrane, and collecting purified water at the second face of water-filtration membrane.

While aspects of the present invention can be described and claimed in a particular statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIG. 1 shows pure water permeability and solute rejection of PVA-PSf composite membranes as function of crosslinking degree with succinic acid as the crosslinking agent.

FIG. 2 shows infrared spectra of succinic acid crosslinked PVA nanofiltration membranes with different degree of crosslinking.

FIG. 3 shows x-ray diffraction spectra for PVA films with different degree of crosslinking.

FIG. 4 shows conceptual illustration of changes in structure of PVA films with (a) 0% crosslinking, (b) 10% crosslinking, (c) 20% crosslinking, and (d) more than 40% crosslinking.

FIG. 5 shows infrared spectra of PVA nanofiltration membranes formed with different crosslinking agents.

FIG. 6 shows water permeability and salt rejection for PVA-PSf composite nanofiltration membranes made from different crosslinking agents.

FIG. 7 shows fractional free volume simulation results for (a) uncrosslinked PVA and PVA crosslinked with (b) succinic acid, (c) maleic acid, (d) malic acid, (e) glutaraldehyde, and (f) suberic acid membranes (probe molecule radius: 1.6 nm).

FIG. 8 shows relationship between experimental pure water permeability and simulated fractional free volume (FFV) of PVA membranes formed with different crosslinking agents (probe molecule radius: 0.16 nm; applied pressure: 150 psi).

FIG. 9 shows amorphous cell models for (a) uncrosslinked PVA, and PVA crosslinked with (b) succinic acid, (c) maleic acid, (d) malic acid, (e) glutaraldehyde, and (f) suberic acid membranes.

FIG. 10 shows the normalized flux across time for four laboratory membranes (M1-M4) and two commercial membranes (M5 and M6) through several cleanings and a change in PSI.

FIG. 11 shows the observed rejection across time for four laboratory membranes (M1-M4) and two commercial membranes (M5 and M6) through several cleanings and a change in PSI.

FIG. 12 shows pure water permeability and salt rejections by PVA-PSf composite membranes at pH 7.0 and 25° C.

FIG. 13 shows a comparison between theoretical and experimental results of combined Spiegler-Kedem—film theory model for NaCl and Na₂SO₄ solutions at pH 7.0 and 25° C.

FIG. 14 shows the effect of pH value of feed solution on the permeability and solute rejection of PVA-PSf composite membranes at 1,034 kPa and 25° C.

FIG. 15 shows the FIB-SEM graphs of the cross-section structure of PVA membranes with different PVA concentration in the casting solution: (a) polysulfone support membranes, PVA-PSf composite membranes with PVA concentrations of (b) 0.05, (c) 0.10, (d) 0.20, (e) 0.30 and (f) 0.50% in the casting solution.

FIG. 16 shows the effect of PVA concentrations in the casting solution (a) and PVA layer thickness (b) on the permeability and solute rejection of PVA-PSf composite membranes at 1,034 kPa pH 7.0 and 25° C.

FIG. 17 shows the effect of PVA molecular weight on the permeability and solute rejection of PVA-PSf composite membranes at 1,034 kPa, pH 7.0 and 25° C.

FIG. 18 shows the FTIR spectra of polysulfone support membrane and PVA nanofiltration membranes with different PVA molecular weight.

FIG. 19 shows the XRD spectra for crosslinked-PVA films comprising different PVA molecular weights.

FIG. 20 shows a comparison of XRD results between uncross-linked PVA and cross-linked PVA with molecular weight of 27,000 Da.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### A. DEFINITIONS

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound If given a name, either by systemic reduction of the compound structure using naming conventions, or by commercially available software, such as CHEMDRAW™ (Cambridgesoft Corporation, U.S.A.).

As used in the specification and the appended claims, the singular forms “a,” “an” and “the” include plural referents unless the context clearly dictates otherwise. Thus, for example, reference to “a composition,” “a fiber,” or “a step” includes mixtures of two or more such functional compositions, fibers, steps, and the like.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an vinyl alcohol residue in a poly(vinyl alcohol) refers to one or more —CH₂CHOH— units in the polymer, regardless of whether vinyl alcohol was used to prepare the poly(vinyl alcohol).

As used herein, the terms “optional” or “optionally” means that the subsequently described event or circumstance can or can not occur, and that the description includes instances where said event or circumstance occurs and instances where it does not.

As used herein, the terms “effective amount” and “amount effective” refer to an amount that is sufficient to achieve the desired result or to have an effect on an undesired condition.

The term “stable,” as used herein, refers to compositions that are not substantially altered when subjected to conditions to allow for their production, detection, and, in certain aspects, their recovery, purification, and use for one or more of the purposes disclosed herein.

As used herein, the term “polymer” refers to a relatively high molecular weight organic compound, natural or synthetic, whose structure can be represented by a repeated small unit, the monomer (e.g., polyethylene, rubber, cellulose). Synthetic polymers are typically formed by addition or condensation polymerization of monomers. Homopolymers (i.e., a single repeating unit) and copolymers (i.e., more than one repeating unit) are two categories of polymers.

As used herein, the term “homopolymer” refers to a polymer formed from a single type of repeating unit (monomer residue).

As used herein, the term “copolymer” refers to a polymer formed from two or more different repeating units (monomer residues). By way of example and without limitation, a copolymer can be an alternating copolymer, a random copolymer, a block copolymer, or a graft copolymer. It is also contemplated that, in certain aspects, various block segments of a block copolymer can themselves comprise copolymers.

As used herein, the term “oligomer” refers to a relatively low molecular weight polymer in which the number of repeating units is between two and ten, for example, from two to eight, from two to six, or form two to four. In one aspect, a collection of oligomers can have an average number of repeating units of from about two to about ten, for example, from about two to about eight, from about two to about six, or form about two to about four.

As used herein, the term “crosslinked polymer” refers to a polymer having bonds linking one polymer chain to another.

As used herein, “oil” can mean any hydrophobic composition having a high carbon and hydrogen content. An oil can be, but is not limited to a plant oil, such as vegetable oil, or a mineral oil, such as petroleum and other petrochemicals. In one aspect, the oil can exist in a water sample as an emulsion.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. OIL-TOLERANT POLYMER MEMBRANES

Described herein are membranes for use in oil-water separations having applications ranging from oil industry wastewater purification to water purification following an oil spill. The oil-tolerant polymer membranes described herein can reject hydrocarbons while not rejecting salts. In one aspect, described herein are oil-tolerant water-filtration membranes comprising a microporous hydrogel coated on at least one side of a porous polymeric support membrane. In one aspect the porous polymeric support membrane can be a polysulfone ultafiltration membrane. In a further aspect the microporous hydrogel coating can be a crosslinked polyvinyl alcohol film. In yet a further aspect, the oil-tolerant water-filtration membranes described herein can be poly(vinyl alcohol)-polysulfone membranes comprising a crosslinked poly(vinyl alcohol) film coated on at lease one side of a polysulfone support membrane. In yet a further aspect, the crosslinked poly(vinyl alcohol) film coating can be stabilized via crosslinking through the utilization of a variety of crosslinking agents, including, but not limited to, succinic acid, maleic acid, malic acid, glutaraldehyde, or suberic acid. In still a further aspect, the crosslinked poly(vinyl alcohol) film can be a thin film such that the film does not completely seal the pores of the porous polymeric support membrane.

It is understood that the disclosed compositions, mixtures, and membranes can be employed in connection with the disclosed methods and uses.

1. Support Membrane

The oil oil-tolerant water-filtration membranes described herein can comprise a porous polymeric support membrane. In one aspect, the hydrophobic support membrane can comprise a polysulfone (PSu) support membrane. Any polysulfone membrane known in the art can be utilized as support membrane in the oil-tolerant water-filtration membranes described herein. For example, and not to be limiting, the polysulfone support membrane can be a commercially available polysulfone ultrafiltration (UF) support membrane. In a further aspect, the polysulfone support membrane can be synthesized by methods known in the art. The structure of polysulfone is

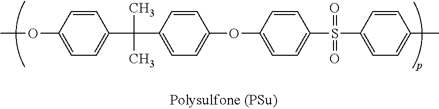

In a further aspect, the porous polymeric support membrane can comprise a polyethersulfone (PES) support membrane. In yet a further aspect, the porous polymeric support membrane can comprise polysulfone and polyethersulfone. The structure of polyether sulfone is

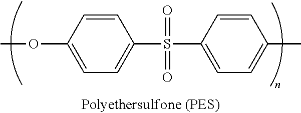

2. Poly(Vinyl Alcohol) Films

In one aspect, the oil-tolerant water-filtration membranes described herein can comprise a film comprising a polymer matrix, wherein the film is substantially permeable to water and salts and substantially impermeable to hydrocarbons and emulsified hydrocarbons. By “polymer matrix” it is meant that the polymeric material can comprise a three-dimensional polymer network. For example, the polymer network can be a crosslinked polymer formed from reaction of at least one polyfunctional monomer with a difunctional or polyfunctional monomer.

a. Polymer Composition

While it is contemplated that the polymer matrix can comprise any three-dimensional polymer network known to those of skill in the art, in one aspect, the film comprises at least poly(vinyl alcohol). Typically, the polymer is selected to be a polymer that can be crosslinked subsequent to polymerization.

b. Crosslinking

In one aspect, to maintain stability and to produce adequate selectivity in molecular separations, the hydrophilic membrane films described herein can be crosslinked. In one aspect, the hydrophilic film can be a poly(vinyl alcohol) film. The crosslinking agents can include, but are not limited to, succinic acid (>99%), maleic acid (>99%), malic acid (>99%,), glutaraldehyde (25% aqueous 6 solution) and suberic acid (>99%). The structures and molecular weights of exemplary crosslinking agents are provided in Table 1 herein. Crosslinking agents can be obtained commercially, for example, from the Sigma-Aldrich company (St. Louis, Mo., USA). In a further aspect, the hydrophilic crosslinked polymeric films can have a degree of crosslinking of about less than 10 percent, about 10 percent, about 20 percent, about 30 percent, about 40 percent, about 50 percent, about 60 percent, about 70 percent, or about 80 percent.

Specific methods of preparing crosslinked poly(vinyl alcohol) membrane films are described in the experimental section herein.

c. Water Contact Angle

Water contact angle is the angle at which a liquid interface meets a solid surface. If a liquid is very strongly attracted to the solid surface (for example water on a strongly hydrophilic solid) the droplet will typically completely spread out on the solid surface and the contact angle will be close to 0°. Less strongly hydrophilic solids typically have a contact angle up to 90°. On many highly hydrophilic surfaces, water droplets typically exhibit contact angles of 0° to 30°. If the solid surface is hydrophobic, the contact angle will typically be larger than 90°.

In one aspect, the oil-tolerant water-filtration membranes described herein comprise a microporous hydrogel coated on at least one side of a porous polymeric support membrane, wherein the membranes have a water contact angle less than 40°. In a further aspect, the oil-tolerant water-filtration membranes described herein can have a water contact angle of less than 40°, less than 30°, less than 20°, less than 10°, or less than 5°.

d. Free Energy of Cohesion

The free energy of cohesion, ΔG₁₃₁, represents the free energy (per unit area) when two surfaces of the same material are immersed in a solvent (water). The free energy of cohesion offers a more fundamental representation of “hydrophobicity” or “hydrophilicity” of a material. The cohesive free energy of cohesion is negative for hydrophobic materials, and positive for hydrophilic materials.

In one aspect, the oil-tolerant water-filtration membranes described herein comprise a microporous hydrogel coated on at least one side of a porous polymeric support membrane, wherein the membranes have a positive free energy of cohesion. In a further aspect, the oil-tolerant water-filtration membranes described herein can have a free energy of cohesion greater than zero but less than 5, 5, 10, 20, 30, 40, 50, or greater than 50.

e. Film Thickness

While the polymer film can be provided at any desired film thickness, the films of the invention are, in one aspect, provided at a thickness of from about 1 nm to about 1000 nm. For example, the film can be provided at a thickness of from about 10 nm to about 1000 nm, from about 100 nm to about 1000 nm, from about 1 nm to about 500 nm, from about 10 nm to about 500 nm, from about 50 nm to about 500 nm, from about 50 nm to about 200 nm, from about 50 nm to about 250 nm, from about 50 nm to about 300 nm, or from about 200 nm to about 300 nm.

The film thickness can be visually confirmed and quantified, for example, by using transmission electron microscopy (TEM). Freger V, Gilron J, Belfer S, “TFC polyamide membranes modified by grafting of hydrophilic polymers: an FT-IR/AFM/TEM study,” Journal of Membrane Science 209 (2002) 283-292.

In one aspect, the hydrogel coating has a thickness sufficient to provide oil rejection of at least about 90% and a normalized flux of at least about 1. For example, the hydrogel coating can have a thickness sufficient to provide oil rejection of at least about 95% and a normalized flux of at least about 5. As a further example, the hydrogel coating can have a thickness sufficient to provide oil rejection of at least about 96% and a normalized flux of at least about 8. In a yet further example, the hydrogel coating can have a thickness sufficient to provide oil rejection of at least about 96% and a normalized flux of at least about 9.

3. Properties

In various aspects, the disclosed membranes can have various properties that provide the superior function of the membranes, including excellent flux, high hydrophilicity, negative zeta potential, surface smoothness, an excellent rejection rate, improved resistance to fouling, and the ability to be provided in various shapes. It is also understood that the membranes have other properties such as enabling oil-water separation with significant removal of hydrocarbons and no rejection of salts.

a. Hydrocarbon Rejection

In one aspect, the disclosed membranes can have an hydrocarbon rejection (e.g., oil rejection) of at least about 80%, for example, at least about 85%, at least about 90%, at least about 92%, at least about 93%, at least about 94%, at least about 95%, at least about 96%, at least about 97%, at least about 98%, at least about 99%, or about 100%. In various aspects, the hydrocarbon rejection represents the portion of hydrocarbon that does not penetrate the membrane.

In various aspects, the membrane can be constructed such that the membrane rejection hydrocarbons but does not reject salts. In further aspects, the membrane can be constructed such that the membrane also rejects salts and has a salt rejection of at least about 80%, for example, at least about 85%, at least about 90%, at least about 92%, at least about 93%, at least about 94%, at least about 95%, at least about 96%, at least about 97%, at least about 98%, at least about 99%, or about 100%.

b. Normalized Flux

In one aspect, the disclosed membranes, while having a minimum hydrocarbon rejection, can also have a flux of at least about 1, for example, at least about 2, at least about 3, at least about 4, at least about 5, at least about 6, at least about 7, at least about 8, at least about 9, or at least about 10.

### C. METHODS FOR PREPARING OIL-TOLERANT POLYMER MEMBRANES

In one aspect, described herein are methods for preparing oil-tolerant water-filtration membranes comprising applying a porous hydrophilic crosslinked polymer coating to at least one side of a porous polymeric support membrane.

In one aspect, the porous hydrophilic crosslinked coating can be a poly(vinyl alcohol) film. The poly(vinyl alcohol) films can be applied to the porous polymeric support membranes using a multi-step coating procedure with dilute poly(vinyl alcohol) aqueous solution. In a further aspect, dilute poly(vinyl alcohol) aqueous solution can be stabilized by an in situ crosslinking technique using a crosslinking agent.

In one aspect, to prepare the membranes described herein, poly(vinyl alcohol) powder can be dissolved in deionized water at 90° C. using mechanical stirring (Fisher Scientific, Pittsburgh, Pa., USA) for about 60 minutes to make poly(vinyl alcohol) aqueous solutions. The poly(vinyl alcohol) molecular weight can be, but is not limited to 47 kDa and the poly(vinyl alcohol) concentration can be, but is not limited to, 0.10 wt %. Next, poly(vinyl alcohol) solutions can be cooled to room temperature and the crosslinking agent can be added, along with 2 M HCl as catalyst, under continuous stirring to produce the poly(vinyl alcohol) casting solution. Crosslinking agent concentration can be selected to produce a theoretical crosslinking degree of about less than 10 percent, about 10 percent, about 20 percent, about 30 percent, about 40 percent, about 50 percent, about 60 percent, about 70 percent, about 80 percent, or about greater than 80 percent, as calculated by equation 1 herein.

In one aspect, a poly(vinyl alcohol) casting solution can be coated onto a polysulfone ultrafiltration membrane one time, two time, three times, or greater than three times. First, the casting solution can be poured onto the polysulfone support membrane and can sit for about 10 minutes. Then, the solute can be drained and the remaining water can be allowed to evaporate at room temperature for about 24 h. Next, the coated membrane can be dropped into the same poly(vinyl alcohol) solution for about 10 seconds and then taken out, and air-dried for 24 hours. The 10-second coating and drying can be repeated a third time to produce a defect-free, ultra-thin poly(vinyl alcohol) coating film. The poly(vinyl alcohol) coated polysulfone membrane can then be cured at 100° C. for about 10 minutes.

More specific methods of fabrication are described in the experimental section herein.

### D. METHODS FOR USING OIL-TOLERANT POLYMER MEMBRANES

In one aspect, described herein are methods for water-filtration comprising providing a water-filtration membrane comprising a microporous hydrogel coated on a porous polymeric support membrane, the water-filtration membrane having a first face corresponding to the discrimination layer and a second face corresponding to the porous support, applying pressure to a water solution, having at least one solute, at the first face of the water-filtration membrane, and collecting purified water at the second face of water-filtration membrane.

It is understood that the product produced by any of the disclosed methods or processes is also disclosed. Further, it is understood that the disclosed processes can be employed in connection with the disclosed fabrics, films and particles.

### E. EXPERIMENTAL

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Tuning the Molecular Structure, Separation Performance and Interfacial Properties of Poly(Vinyl Alcohol)-Polysulfone Interfacial Composite Membranes.

Interfacial composite membranes were prepared by dip-coating poly(vinyl alcohol) hydrogels on polysulfone ultrafiltration (UF) support membranes. Ultra-thin poly(vinyl alcohol) films were cast using multi-step coating procedure with dilute poly(vinyl alcohol) aqueous solutions and stabilized by a novel in situ crosslinking technique using five different crosslinking agents. The effects of crosslinking degree and crosslinking agent on the molecular structure, separation performance and interfacial properties of poly(vinyl alcohol)-polysulfone composite membranes were investigated. Separation performance was investigated using sodium chloride and sodium sulfate solutions. The extent of crosslinking, surface thermodynamic properties, crystallinity and free volume properties of poly(vinyl alcohol)-polysulfone membranes were characterized by FTIR, contact angle titration, XRD, and molecular dynamic simulations. Higher degrees of crosslinking correlated with lower PVA film crystallinity and decreased hydrophilicity, but did not correlate with flux and rejection data. Experimentally determined permeability data correlated with simulated fractional free volumes of the crosslinked poly(vinyl alcohol) membranes demonstrating the importance of polymer free volume (i.e., steric exclusion and hindered diffusion) in solvent and solute transport through nanofiltration membranes.

A multi-step coating method followed by in situ crosslinking was employed to prepare interfacial composite membranes with ultra-thin, defect-free PVA coating films. To develop composite PVA membranes with NF-like separation performance, cross-linked PVA hydrogels were coated over polysulfone ultrafiltration membranes were prepared using different crosslinking agents. The effects of crosslinking degree, crosslinking agent, and dry curing conditions on the molecular structure and transport properties of PVA-PSf composite nanofiltration membranes was investigated using molecular dynamics simulation, infrared spectroscopy, X-ray diffraction and separation performance studies.

Molecular dynamics simulations in this study were carried out using Discover and Amorphous cell modules of Materials Studio (Accelrys Software, Inc.). The condensed phase optimization of molecular potentials for atomistic simulation studies (COMPASS) force field was employed for all molecular dynamics simulation in this study. The energy minimization process was conducted using the smart minimizer method, which started from steepest-descent to conjugated-gradient and then to the Newton method as the energy derivatives decreased. For molecular dynamics simulation, the constant temperature and pressure were controlled by Andersen thermostat and Berendsen barostat methods, respectively. Nonbond cutoff distance was set as 9.5 Å (with a spline width of 1.0 Å and a buffer width of 0.5 Å) to calculate the nonbonding energies. Long-tail corrections to the energy due to cutoff were employed during dynamics simulation and the time step was set as 1 fs for all dynamics runs.

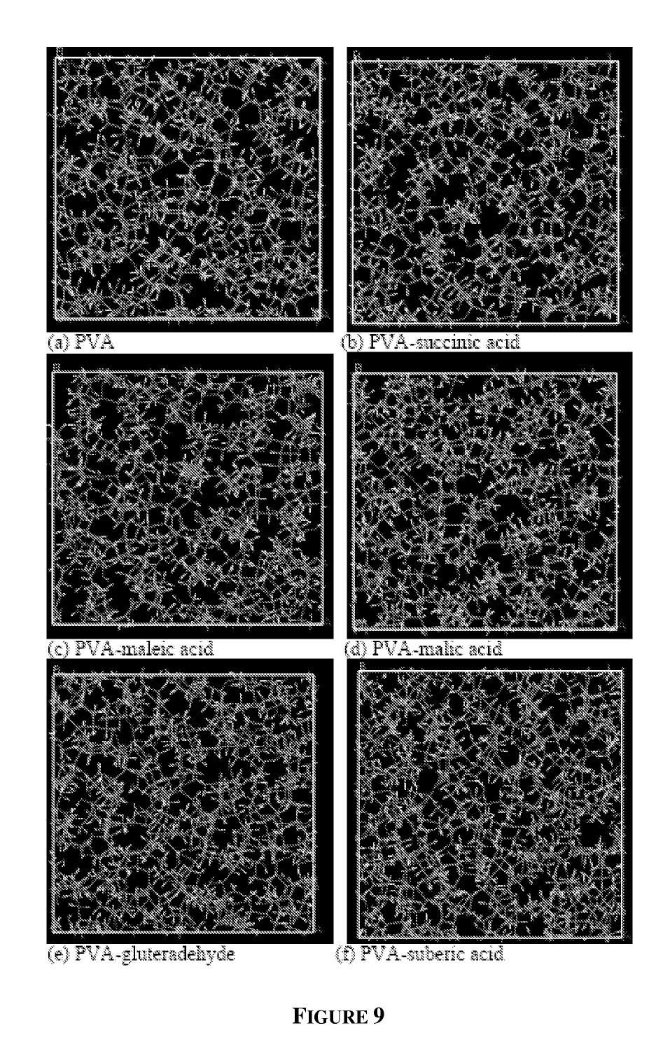

Molecular models of uncross-linked PVA and cross-linked PVA polymers using different cross-linking agents (Table 1) were constructed in this study. The developed PVA model and PVA-succinic acid, PVA-maleic acid, PVA-malic acid, PVA-glutaraldehyde, PVA-suberic acid cross-linked polymer models were constructed by Amorphous cell module (FIG. 9). For the uncross-linked PVA model, atactic PVA polymer chains consisting of 45 4 repeat units were built with a 50:50 probability for the occurrence of cis and trans configurations.

The packing model contained five PVA polymer chains with a density of 1.27 g/cm3. The crosslinked PVA membrane model was identical except for the addition of 22 crosslinking agent molecules. A 2,000-step energy minimization was carried out at the beginning phase to eliminate local non-equilibrium for all amorphous cell models. Three types of crosslinking potentially existed in the crosslinked PVA membranes: (1) self-crosslinking of PVA between —OH groups of PVA polymer chains; (2) crosslinking between one carboxylic group of succinic acid and an —OH group in PVA polymer chain, i.e., partial crosslinking; (3) crosslinking between both carboxylic groups of succinic acid and —OH groups in PVA polymer chains, i.e., complete crosslinking. Molecular dynamic simulations assumed a crosslinking degree of 20%, which was calculated from

$${χ}_{CL} [ \% ] = \frac{{W}_{CL} \times {MW}_{PVAunit} \times 2}{{W}_{PVA} \times {MW}_{CL}} \times 100 , \qquad ( 1 ) ,$$

where W_{CL}, W_{PVA}, MW_{PVAunit}, and M_{WCL} represented the weight of crosslinking agent, the weight of PVA, the molecular weight of one PVA unit (—CHOH—CH₂—), and the molecular weight of the crosslinking agent, respectively.

The resulting atomistic structures were subsequently optimized by the following procedure as described previously. The resulting atomistic structures were optimized by a 5,000-step energy minimization followed by a 100 ps MD equilibration run performed in the NPT (T=300 K, P=1.01×10⁵ Pa) ensemble to further equilibrate the models. This was followed by an annealing procedure by which the system was heated from 300 K to 600 K at intervals of 50 K and then cooled back. At each step 150 ps NPT dynamics was applied on the cell. Afterwards, a 100 ps MD equilibration run was performed in the NPT (T=300 K, P=1.01×10⁵ Pa) ensemble to obtain the equilibrium state. The length of the final periodic boundary cubic cell varied from 24.60 to 32.80 Å depending on the different crosslinking agent chemical structures. An additional 100 ps NVT (T=323 K) dynamics was performed on the endpoint of the NPT run to obtain the equilibrium molecular structures and the atomic trajectory was recorded every 50 ps for later analysis.

The simulated atomistic models allow an accurate determination of geometrical quantities characterizing the structure. The fractional free volume (FFV) of the equilibrated uncrosslinked PVA membranes and crosslinked PVA membranes were determined by a hard spherical probe. The atoms composing the membranes are represented by hard spheres with van der Waals radius (C, 1.55 Å; H, 1.10 Å; O, 1.35 Å). The probe molecules, which were modeled by spheres with radii 1.6 Å, respectively, were chosen in this study. The Connolly surface was calculated when the probe molecule with the radius rolled over the van der Waals surface, and free volume is defined as the volume on the side of the Connolly surface without atoms. The fractional free volume was determined by the ratio of free volume to total volume of the model. The free volume obtained by this method excluded the volume that was inaccessible for the probes.

The chemicals and materials used were as follows: Mowiol® PVA 6-98 with average molecular weights of 47,000 g/mol, respectively, 98.0-98.8% hydrolyzed, was purchased from Sigma-Aldrich Company (St. Louis, Mo., USA) for the formation of active layers of the NF composite membranes. Commercial polysulfone ultrafiltration membranes (NanoH₂O Inc., Los Angeles, Calif., USA) were used as supports on which the PVA films were cast. Crosslinking agents succinic acid (>99%), maleic acid (>99%), malic acid (>99%,), glutaraldehyde (25% aqueous 6 solution) and suberic acid (>99%) were used as received from Sigma-Aldrich company (St. Louis, Mo., USA) (Table 1).

TABLE 1
CROSSLINKING AGENTS INVESTIGATED

| Common | Chemical | | |
|---|---|---|---|
| Name | Formula | Chemical Structure | M_{W} |
| Succinic acid | C₄H₆O₄ | 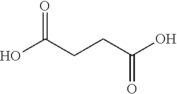 | 118.09 |
| Maleic acid | C₄H₄O₄ | 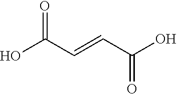 | 116.07 |
| Malic acid | C₄H₆O₅ | 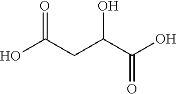 | 134.09 |
| Gluta- ralde- hyde | C₅H₈O₂ | 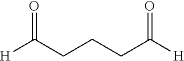 | 110.12 |
| Suberic acid | C₈H₁₄O₄ | 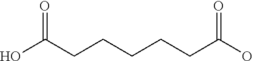 [SMILES: O=C(O)CCCCCC(=O)O] | 174.19 |

Membranes were prepared as follows: Poly(vinyl alcohol) powder was dissolved in DI water at 90° C. using mechanical stirring (Fisher Scientific, Pittsburgh, Pa., USA) for about 60 minutes to make PVA aqueous solutions. Unless otherwise specified, the PVA molecular weight was 47 kDa and the PVA concentration was 0.10 wt %. Next, PVA solutions were cooled to room temperature and the crosslinking agent was added along with 2 M HCl as catalyst under continuous stirring to produce the PVA casting solution. Crosslinking agent concentration was selected to produce a theoretical crosslinking degree of 20 percent (as calculated by eq. 1) unless otherwise specified.

Poly(vinyl alcohol) casting solutions were coated onto polysulfone ultrafiltration membranes for three times. First, the casting solution was poured onto the PSf support and let sit for 10 minutes. Then, the solute was drained and the remaining water was allowed to evaporate at room temperature for 24 h. Next, the coated membrane was dropped into the same PVA solution for 10 seconds and then taken out, and air-dried for 24 h again. The 10-second coating and drying was repeated a third time to produce defect-free ultra-thin PVA coating films. The PVA coated polysulfone membranes were then cured at 100° C. for 10 minutes.

Membranes were characterized as follows: the extent of crosslinking of PVA coating layers was confirmed by attenuated total reflection infrared spectroscopy (ATR-IR) performed on a Jasco FTIR 670 plus with variable angle ATR attachment coupled to a germanium crystal operated at a angle of 45 degrees. Prior to the ATR-IR measurement, the samples were dried in a desiccator for a minimum of 24 hours. Crystallinity of PVA coating films was characterized by X-ray diffraction, XRD (Bruker AXS D8 diffractometer, Germany, using Cu-Kα radiation).

The membrane surface hydrophilicity, surface tensions, and interfacial free energies were determined from measured contact angles using an automated contact angle goniometer (DSA0 KRÜSS GmbH, Hamburg, Germany). At least twelve equilibrium contact angles were measured for each sample. The highest and lowest values were discarded before taking the average and standard deviation. Contact angle measurements for deionized water (polar liquid), diiodomethane (apolar liquid) and glycerol (polar liquid) enables determination of surface tension parameters using the extended Young-Dupre equation. here, as elsewhere, “wettability” is defined from the surface roughness corrected solid-liquid interfacial free energy, −ΔG₁₃, and “hydrophilicity” from the surface roughness corrected interfacial free energy of cohesion, ΔG₁₃₁.

Separation performance was evaluated as follows: The separation performance of PVA-PSf composite membranes was evaluated in a bench scale crossflow membrane filtration system equipped with six parallel membrane cells (effective membrane area is 12.9 cm² for each membrane cell). Pure water flux of polysulfone and PVA-PSf membranes were determined using 18 MΩ laboratory de-ionized water at 25° C. and applied pressures of 173 and 1,034 kPa (25 and 150 psi), respectively. The crossflow Reynolds number was maintained at 312 without a mesh spacer in the feed channel. Flux was measured by a digital flow meter (Optiflow 1000; Agilent Technology, Foster City, Calif.). Nanofiltration membrane selectivity was characterized by evaluating the conductivity rejection of 2,000 ppm NaCl and Na₂SO₄ solutions. Conductivity calibration curves were linear for concentration between 0 and 2,000 ppm of these salts; hence, observed rejections calculated directly from feed and permeate conductivities. All reported flux and rejection data represent the averages of at 8 least three separate tests of membranes hand-cast on three different days using independently prepared PVA coating solutions.

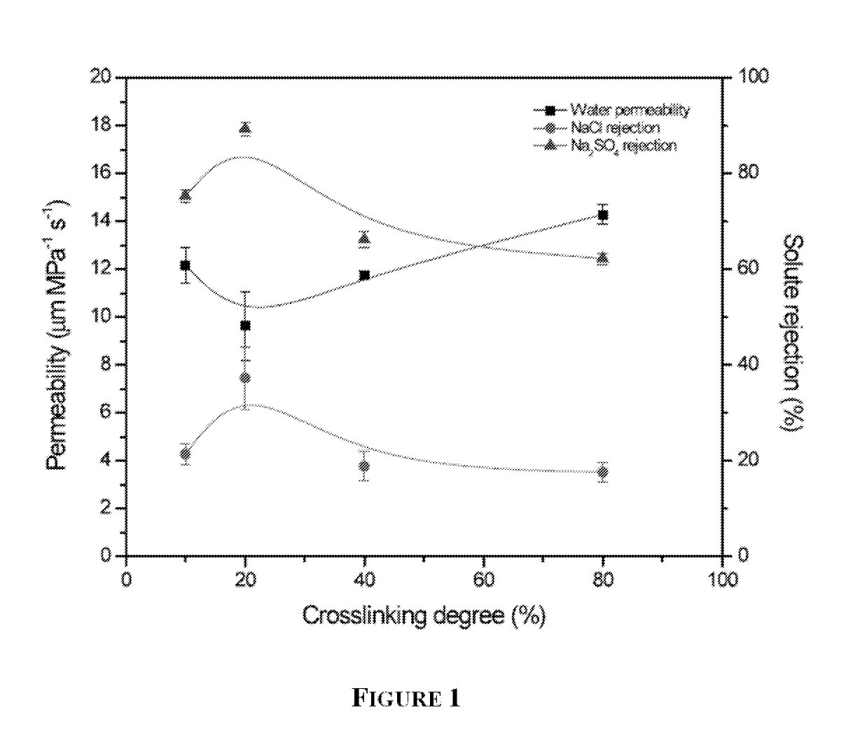

The effects of crosslinking degree were as follows: succinic acid was the cross-linking agent used to evaluate the impacts of cross-linking degree on structural and separation properties of PVA-PSf composite membranes. The pure water permeability of PVA-PSf composite membranes decreased slightly with increasing cross-linking degree from 10% to 20%, then the permeability increased with crosslinking degree increasing from 20% to 80% (FIG. 1). At 80% crosslinking, the pure water permeability was 14.3 μm·MPa⁻¹·s⁻¹. Rejection of 2,000 ppm NaCl and 2,000 ppm Na₂SO₄ increased with increasing crosslinking degree from 10% to 20%, then the rejection decreased with increasing crosslinking degree from 20% to 80%. The rejections of NaCl and Na₂SO₄ by crosslinked PVA-PSf composite membranes with 20% crosslinking were 37.5% and 90.5%, respectively.

The contact angle of DI water increased with increasing crosslinking degree from 10%) (24° to 80%(38°) (Table 2), which indicates PVA-PSf composite membranes become less hydrophilic with increasing crosslinking degree. The surface roughness corrected solid-liquid interfacial free energy, −ΔG₁₃, is a more fundamental property for describing the wettability of solid surface. Typically, a condensed-phase material is considered wetting if −ΔG₁₃>72.8 mJ/m², which corresponds to a contact angle of 90° for pure water at 20° C. as expected from contact angle results. PVA-PSf composite membranes with lower crosslinking degrees were more wettable. The Lifshitz-van der Waals (apolar) and Lewis acid-base (polar) components of surface tension both decreased with higher degrees of crosslinking. The lower total solid surface tension made less wetting surface.

TABLE 2
INTERFACIAL TENSIONS AND FREE ENERGIES OF MEMBRANES

| | | Contact angle | DI | γ [symbol] | γ [symbol] | γ⁻ | γ [symbol] | γ [symbol] | −Δ [symbol] | Δ [symbol] |
|---|---|---|---|---|---|---|---|---|---|---|
| Liquid/Membrane | Diiodomethane | Glycerol | Water | [symbol] | [symbol] | [symbol] | [symbol] | [symbol] | [symbol] | [symbol] |
| [symbol] | n/a | n/a | n/a | 50.8 | 0.0 | 0.0 | 0.0 | [symbol] | n/a | n/a |
| Glycerol | n/a | n/a | n/a | 34.0 | 3.8 | 57.4 | 29.9 | 63.9 | n/a | n/a |
| DI water | n/a | n/a | n/a | 21.8 | 25.5 | 25.5 | 51.0 | 72.8 | n/a | n/a |
| [symbol] | 14.5 ± 0.9 | 63.2 ± 0.7 | 74.3 ± 0.3 | 49.2 | 0.00 | 7.0 | 0.2 | 49.4 | 92.5 | −59.4 |
| PVA (10% [symbol] ) | 23 ± 1.1 | 35 ± 0.5 | 24.4 ± 3.1 | 46.8 | 0.21 | [symbol] | 6.3 | 53.2 | 139.1 | [symbol] |
| PVA (20% [symbol] ) | 24.4 ± 0.4 | 40 ± 1.2 | 28.6 ± 2.1 | 48.4 | 0.19 | 46.3 | 5.9 | 52.3 | [symbol] | 23.2 |
| PVA (40% [symbol] ) | 28.4 ± 1.2 | 43.4 ± 1.4 | 33.7 ± 1.1 | [symbol] | 0.17 | 43.6 | 6.4 | 50.2 | 133.4 | 20.6 |
| PVA (80% [symbol] ) | 28.6 ± 0.9 | 49.3 ± 0.8 | 37.5 ± 0.3 | [symbol] | 0.01 | 44.3 | 1.1 | 45.9 | 130.6 | 23.7 |
| PVA-succinic acid | 20.7 ± 0.4 | 36.4 ± 1.2 | 24.5 ± 2.1 | 47.6 | 0.26 | 47.3 | 7.1 | 54.6 | 139.0 | 23.2 |
| PVA- [symbol] acid | 32.9 ± 0.8 | 34.4 ± 1.8 | 27.3 ± 1.1 | 43.0 | 0.86 | [symbol] | 12.3 | 55.3 | 137.5 | 18.9 |
| PVA- [symbol] acid | 35.6 ± 2.4 | 48.9 ± 0.6 | 21.6 ± 3.6 | 41.8 | 0.00 | 64.0 | 1.1 | 42.9 | 140.6 | 52.4 |
| PVA- [symbol] | 34.0 ±2.1 | 38.3 ± 1.7 | 26.4 ± 2.9 | 42.5 | 0.50 | 48.1 | 9.8 | 52.3 | [symbol] | 26.9 |
| PVA-suboric acid | 27.7 ± 3.9 | 61.4 ± 3.1 | 19.1 ± 1.20 | 45.1 | 0.23 | 68.7 | 8.0 | 53.1 | 141.6 | [symbol] |

[symbol]

Crosslinking degree (crosslinking agent: succinic acid)
Curing temperature and time: 100° C./10 minutes. [symbol]
indicates data missing or illegible when filed

The interfacial free energy of cohesion (at contact), ΔG₁₃₁, represents the free energy (per unit area) when two surfaces of the same material are immersed in a solvent (water). The free energy of cohesion offers a more fundamental representation of “hydrophobicity” or “hydrophilicity” of a material. The cohesive free energy of cohesion is negative for hydrophobic materials, and positive for hydrophilic materials. The PSf support membrane was hydrophobic (−59.4 mJ/m²). All PVA-PSf composite membranes were hydrophilic (>20 mJ/m²). Quantitatively, hydrophilicity decreased with higher degrees of crosslinking.

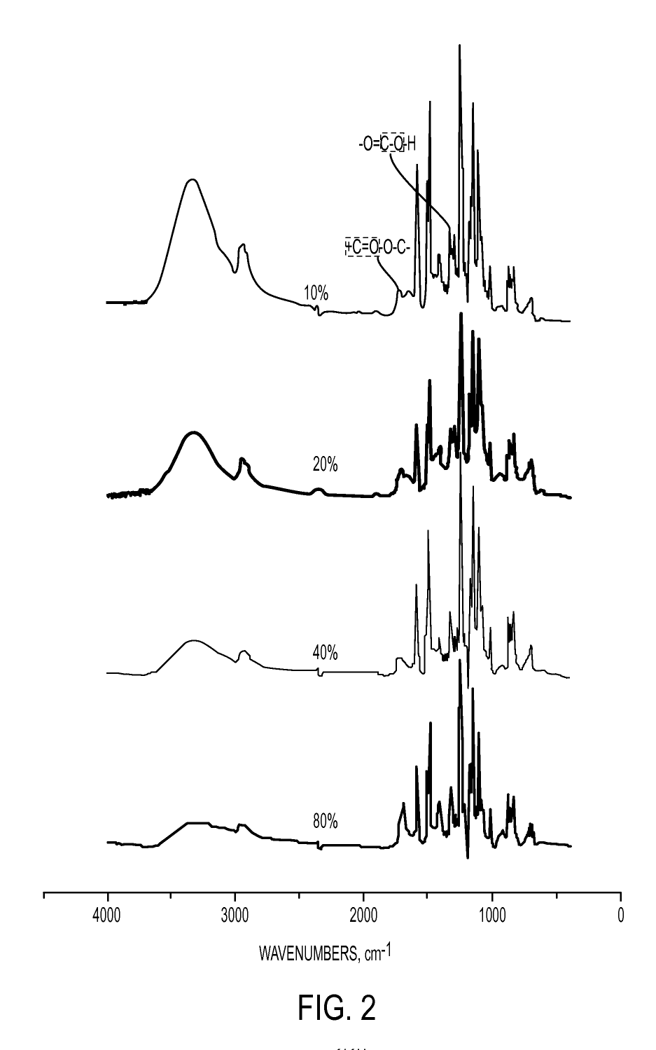

Infrared spectra of PVA-PSf composite membranes (FIG. 2) gave the absorption at 3,000-3,600 cm⁻¹, which indicated the stretch of hydroxyl groups. The intensity of these peaks decreased with cross-linking degree increasing; hence, the PVA-PSf composite membranes hydrophilicity was due to hydroxyl groups of PVA and carboxyl groups from unreacted succinic acid. The peaks at 1,630-1,760 cm⁻¹ are the stretch of the —C═O— groups in —C═O—O—C— groups, whose intensity correlated with the extent of crosslinking. As shown in FIG. 2, the intensity of peak at 1,630-1,760 cm⁻¹ for PVA-PSf composite membranes with crosslinking degree of 80% was the highest. At 10% and 20% cross-linking, there were two-peaks at 1,630-1,760 cm⁻¹ because of incomplete crosslinking at 40% and 80% crosslinking, there was only one peak at 1,630-1,760 cm⁻¹ indicating more complete crosslinking between PVA and succinic acid. The peak at around 1,300 cm⁻¹ was the stretch of —C—O— group in —C═O—O—H groups. The intensity of this peak was lower if as the extent of crosslinking increased.

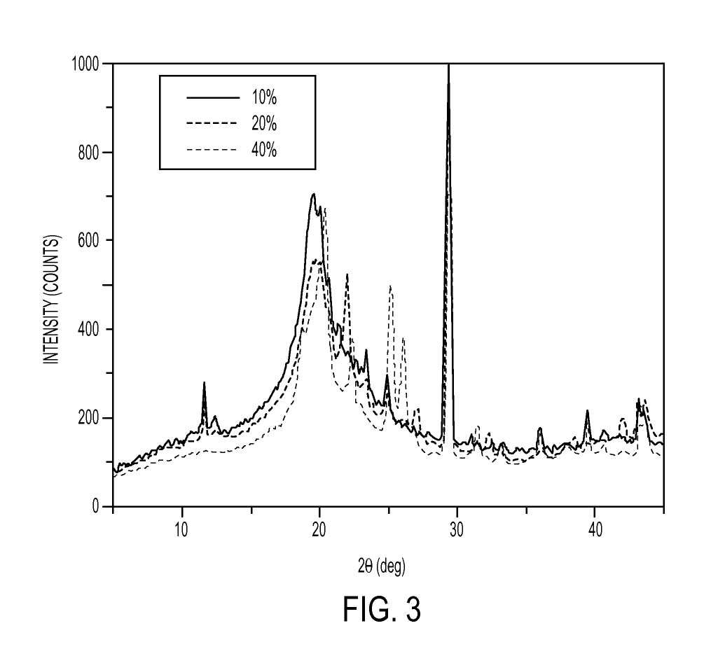

Crosslinking disrupts crystalline regions of PVA. From XRD analysis, the peak at 19.6° (FIG. 3) was the characteristic peak for PVA polymer; the intensity of the peak decreased with increasing crosslinking. Hence, PVA crystallinity decreased, which is evident for the PVA-PSf composite membranes with crosslinking degree of 40%, the PVA characteristic peak at 19.6° was mostly destroyed, separating into several small peaks. This is why PVA-PSf composite membranes with higher crosslinking degree showed higher permeability.

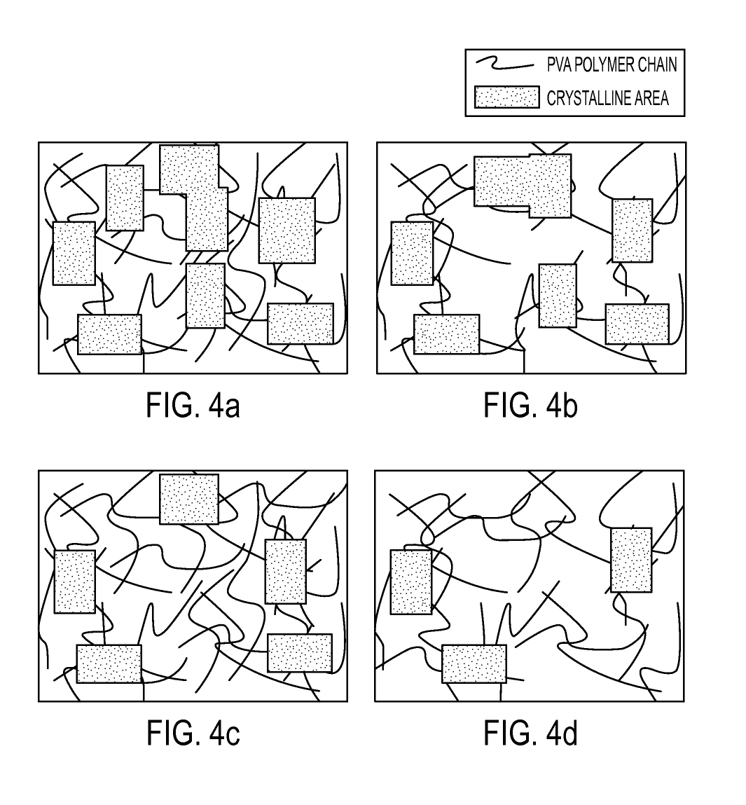

According to these results of characterization and separation properties, the possible structure change of crosslinked PVA membrane is illustrated in FIG. 4. Regarding the uncrosslinked PVA membranes, there are multiple crystalline areas due to the semi-crystalline structure of PVA films. At lower crosslinking degree (<20%), PVA crystallinity was not completely disrupted and these membranes showed higher permeability and lower rejection. But for 20% crosslinking degree, there were some small peaks in XRD results, which means the crosslinking reaction happened in mostly area, but possible form new crystalline structure due to crosslinking structure. At higher crosslinking degree (>40%), the crosslinking reaction was nearly complete, and hence, crystallinity was reduced, which produced higher permeability and lower rejection.

The effects of crosslinking agent structure were as follows: five crosslinking agents (Table 1) with different chemical structures were chosen to make PVA-PSf composite membranes. Succinic, malic, and maleic acid have the same number of carbon atoms, but maleic acid has carbon double bond and malic acid has an added hydroxyl group that can impart hydrophilicity. Suberic acid offered a larger crosslinking agent that could create a “looser” crosslinked polymer network structure, while glutaraldehyde could produce the “tightest” film because of the reduced oxygen content (relative to the dicarboxylic acids).

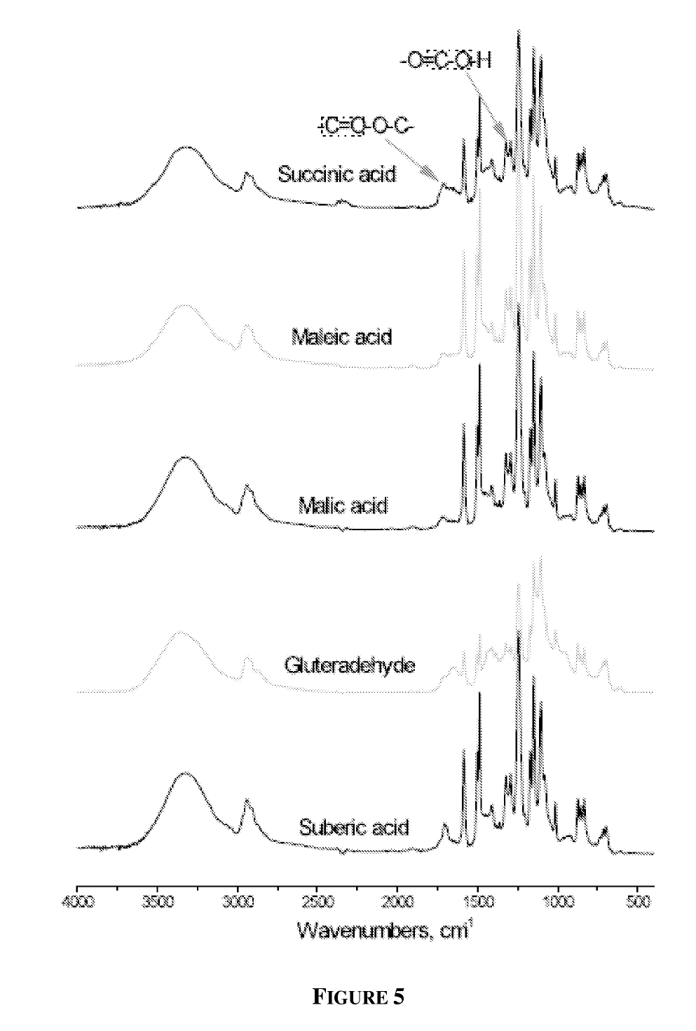

Infrared spectra of PVA-PSf composite membranes made from different crosslinking agents are shown in FIG. 5. The stretch of —C═O— in —C═O—O—H group should be at 1,820-1,750 cm⁻¹, but there were no peaks at the wavenumber in this spectra for all the PVA-PSf membranes. For PVA-glutaraldehyde-crosslinked PVA, there were only —C—C═O—C— groups, shown at the peak of 1,715 cm⁻¹. PVA-glutaraldehyde films did not have —C═O—O— groups, but PVA-PSf membranes crosslinked with all other dicarboxylic acid crosslinking agents exhibited the stretch at 1,570 cm⁻¹ for —C═O—O— groups. The peak at around 1,300 cm⁻¹ was the stretch of —C—O— groups in —C═O—O—H groups. The intensity of this peak for PVA-succinic acid, PVA-maleic acid, PVA-malic acid and PVA-suberic acid membranes were almost similar, but that was lowest for PVA-glutaraldehyde membrane because there were no —C—O— groups in PVA-glutaraldehyde membranes.

The contact angle for deionized water on all five PVA membranes was between 19 and 25 degrees. Different crosslinking agents produced subtly different surface chemistry and hydrophilicity. For example, PVA-malic acid and PVA-suberic acid membranes were slightly more wettable because of the extra —OH groups in malic acid molecules and longer molecular chain of suberic acid molecules, both of which produced lower degrees of crosslinking. PVA-maleic acid was less wettable due to —C═C— bond in maleic acid. The interfacial free energy of cohesion of these PVA membranes decreased as follows (Table 2): PVA-malic acid>PVA suberic acid>PVA-glutaraldehyde>PVA-succinic acid>PVA-maleic acid. However, the cohesive free energies were all larger than 20 mJ/m²; hence, all of these crosslinked PVA membranes were hydrophilic.

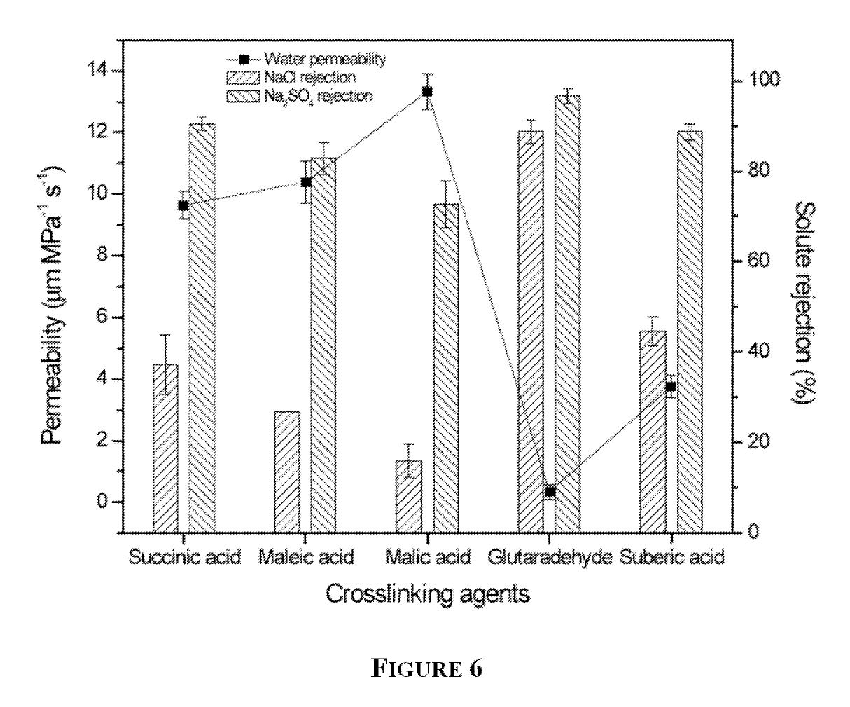

For the crosslinking agents (succinic acid, maleic acid, and malic acid) with the same carbon atom number, malic acid crosslinked membranes had the highest pure water permeability while succinic acid crosslinked membranes had the lowest permeability; salt rejection changed oppositely (FIG. 6). These results came from the steric effects of the different functionality in the order of most to least steric hindrance: —OH (malic acid)>C═C (maleic acid)>none (succinic acid). For glutaraldehyde crosslinked membranes, the rejection of both NaCl and Na₂SO₄ were high (88.7 and 96.6%, respectively), but the pure water permeability was very low (0.4 μm·MPa⁻¹·s⁻¹) because the crosslinking reaction between PVA and glutaraldehyde is very fast and the real degree of crosslinking increases. Membranes crosslinked with suberic acid showed similar solute rejections as succinic acid, but pure water permeability much lower (3.8 μm·MPa⁻¹·s⁻¹). Suberic acid is much larger than succinic acid, so the crosslinking reaction is slower and the ability to disrupt PVA crystallinity is weaker.

The effects of polymer free volume were as follows: there are two phases in polymer membranes: a solid phase occupied by the polymer chains and a void phase referred to as “polymer free volume”. Free volume size and distribution serve as the most convenient and direct descriptors of the molecular pore structure of dense membranes, and have the potential to connect microscopic membrane morphology with macroscopic separation performance. While positron annihilation lifetime spectroscopy (PALS) is the prevalently adopted experimental method to determine the free volume quantitatively, the experimental technique is often inaccurate and cannot clearly give detailed information about the morphology of the free volume voids. Molecular dynamics (MD) simulations can be employed to characterize the free volume of dense polymeric membranes.

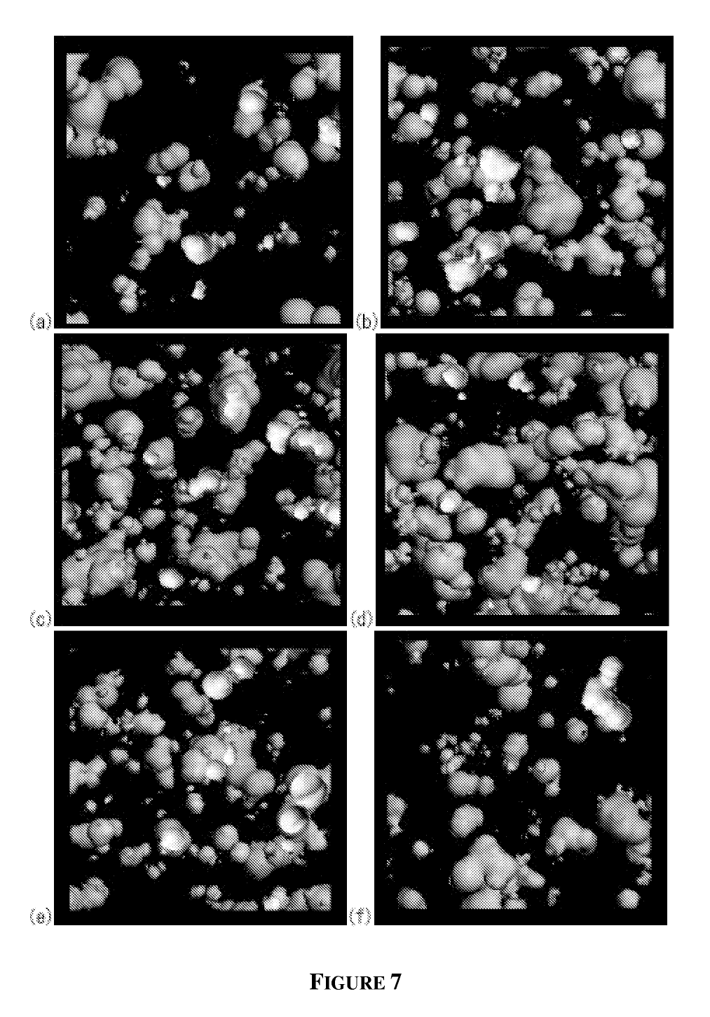

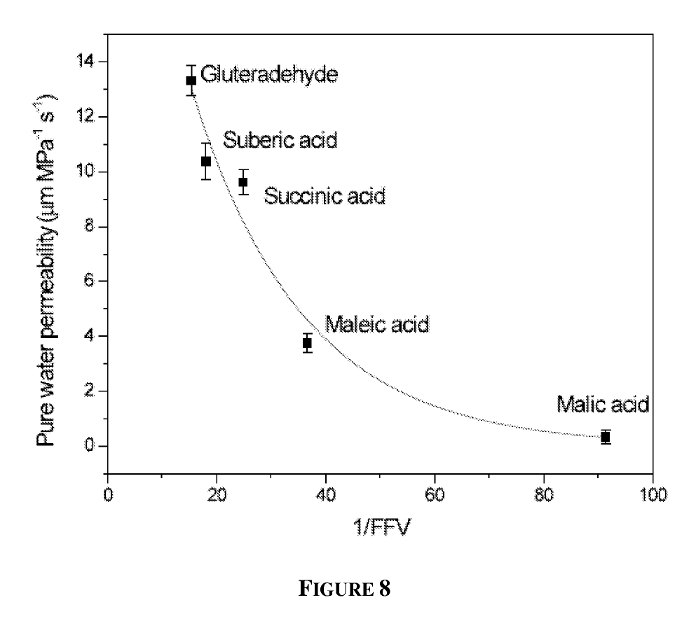

Pictures of the free volume morphology of all PVA membranes with and without different crosslinking agents using molecule probes with radii of 1.6 nm are shown in FIG. 7 and the FFV values are shown in FIG. 8. The FFV decreased rapidly as the probe size increased.

The FFV of PVA membranes increased as follows: glutaraldehyde (1.09%), uncrosslinked (2.62%), suberic acid (2.73%), succinic acid (4.01%), maleic acid (5.53%), 13 malic acid (6.52%). The pure water permeability and fractional free volume appeared highly correlated (FIG. 8).

The FFV reveals qualitative and quantitative-like information for comparison of polymer structures. FFV is the proportion of space between polymer segments, which provides a route for molecule diffusion. According to Fujita's free volume theory, the mobility of penetrant in polymer, Mp is defined as

$${M}_{p} = A exp ( - \frac{B}{FFV} ) . \qquad ( 2 )$$

Here A and B are constants independent of the penetrant concentration and temperature, but dependent only on penetrant size. This equation indicates an increase in mobility Mₚ with increasing FFV. The pure water permeability P_{W} is also described as a function of FFV,

$${P}_{W} = {A}_{P} exp ( - \frac{{B}_{P}}{FFV} ) , \qquad ( 3 ) ,$$

where A_{P} is a constant based on the size and kinetic velocity of the penetrant and feed composition at a particular temperature, and B_{P} is a constant that is related to the free volume cavity necessary for penetrant diffusion.

Many past studies used these relationships to rationalize the effects of fractional free volume on gas permeability in glassy polymers. Based on a least-squares regression analysis, the A_{P} and B_{P} values for crosslinked PVA membranes (without regard to the specific chemistry of the crosslinking agent) in Eq. (3) are 27.65 and 0.049. The strength of this correlation between fractional free volume and water permeability indicated that such molecular dynamic simulations could be used as the basis for molecular design of crosslinked PVA (and other crosslinked polymer) coating films for practical separation problems.

2. Oil-Water Separation Test

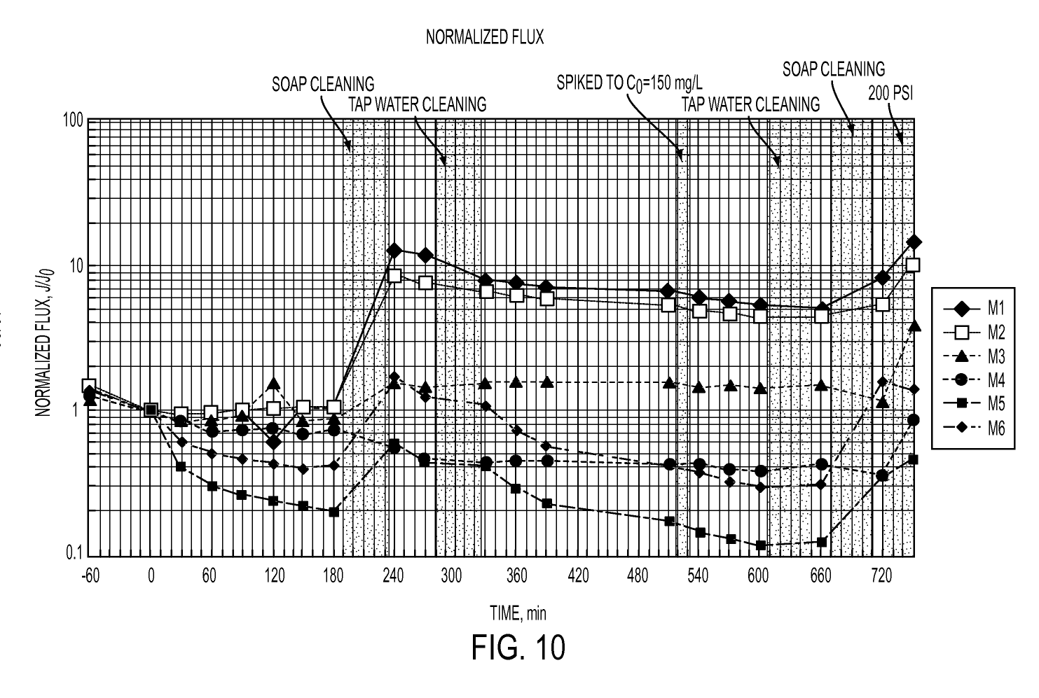

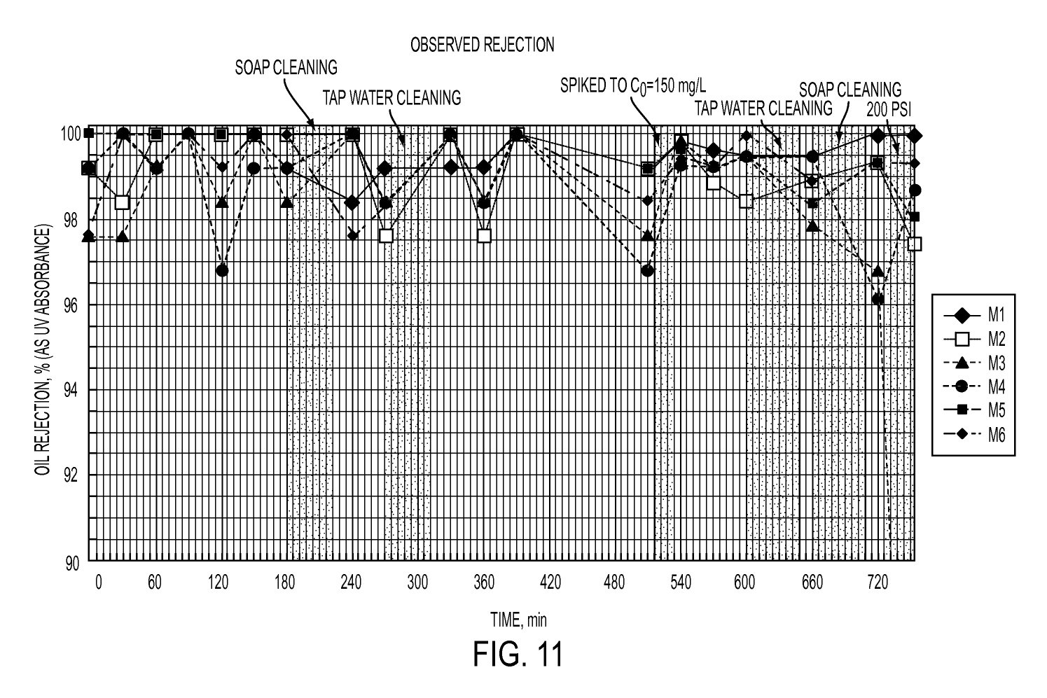

Ocean water collected just south of the Santa Monica pier (at Bay Street parking lot) was used. Used motor oil (obtained from Jiffy Lube in Los Angeles) was mixed into the ocean water at 50 ppm-oil, which was then shaken vigorously for 2 hours to create a highly stable microemulsion. Oil contaminated ocean water was filtered through 6 laboratory prepared membranes (M1, M2, M3, and M4) and two commercial membranes (M5 and M6) at 100 psi feed pressure. The laboratory prepared membranes were prepared according to the method described in Example 1 to produce oil-tolerant ultrafiltration membranes. The results of the experiments involving M1-M6 are shown in FIG. 10 and FIG. 11. Several cleanings were performed using tap water and an industrial detergent (“soap”). Oil rejection was >96% for all membranes. Lab-prepared membranes (M1, M2, M3, and M4) maintained flux much better than commercial membranes. In some cases (M1 and M2), flux increased substantially after cleaning to higher flux than the initial (clean membrane) flux while maintaining their rejection. Pressure was increased to 200 psi after the third cleaning.

These studies demonstrated that ultra-thin and defect-free crosslinked poly(vinyl alcohol) hydrogels were successfully coated over polysulfone ultrafiltration membranes to produce PVA-PSf interfacial composite membranes with nanofiltration separation characteristics. Coating film formation relied on multiple coatings using dilute PVA solutions in combination with in situ crosslinking. The effects of extent of crosslinking and crosslinking agent chemical structure on membrane structure and performance were investigated. Pure water permeability and solute rejection correlated strongly with extent of crosslinking. Infrared spectroscopy indicated the PVA crosslinking reaction formed —C═O—O—C— groups. The PVA membranes were all very hydrophilic with water contact angles ranging between about 19° and 38° depending on different crosslinking agents and extent of cross-linking. Polymer free volume determined by molecular dynamics simulations correlated strongly with pure water permeability indicating that molecular design of crosslinked PVA membranes (in a predictive manner) is practical.

3. Production of PVA Coated Polysulfone Membranes

PVA coated polysulfone membranes were manufactured as shown below in Table 3.

TABLE 3
EXPERIMENTAL DESIGN FOR PVA-COATED
PSU MEMBRANES

| | PVA | PVA | IPA/ | Cross- | CL | Curing | Post- |
|---|---|---|---|---|---|---|---|
| | hydrolysis | % | H2O | linker | % | temp/time | treatment |
| 1 | 88% | 0.1 | 1/9 | Malic | 20 | 100/10 | None |
| | | | | acid | | | |
| 2 | 88% | 0.1 | 0 | Malic | 20 | 100/10 | None |
| | | | | acid | | | |
| 3 | 88% | 0.1 | 1/9 | Malic | 20 | 100/10 | HCl |
| | | | | acid | | | (pH = 1) |
| 4 | 88% | 0.1 | 0 | Malic | 20 | 100/10 | HCl |
| | | | | acid | | | (pH = 1) |
| 5 | 88% | 0.1 | 1/9 | Malic | 20 | 100/10 | NaOH |
| | | | | acid | | | (pH = 13) |
| 6 | 88% | 0.1 | 0 | Malic | 20 | 100/10 | NaOH |
| | | | | acid | | | (pH = 13) |
| 7 | 98% | 0.1 | 1/9 | Malic | 20 | 100/10 | None |
| | | | | acid | | | |
| 8 | 98% | 0.1 | 0 | Malic | 20 | 100/10 | None |
| | | | | acid | | | |
| 9 | 98% | 0.1 | 1/9 | Malic | 20 | 100/10 | HCl |
| | | | | acid | | | (pH = 1) |
| 10 | 98% | 0.1 | 0 | Malic | 20 | 100/10 | HCl |
| | | | | acid | | | (pH = 1) |
| 11 | 98% | 0.1 | 1/9 | Malic | 20 | 100/10 | NaOH |
| | | | | acid | | | (pH = 13) |
| 12 | 98% | 0.1 | 0 | Malic | 20 | 100/10 | NaOH |
| | | | | acid | | | (pH = 13) |

| | |
|---|---|
| 13 | Polysulfone membrane as control |

4. Transport, Structural, and Interfacial Properties of Poly(Vinyl Alcohol)-Polysulfone Composite Nanofiltration Membranes

Mowiol® PVA 4-98, 6-98, 10-98 with average molecular weights of 27,000, 47,000 and 61,000 g/mol, respectively, 98.0-98.8% hydrolyzed, was purchased from Sigma-Aldrich Company for the formation of active layers of the NF composite membranes. Commercial polysulfone ultrafiltration membranes (NanoH₂O Inc., Los Angeles, Calif., USA) were used as supports on which the PVA films were cast. Succinic acid (>99%, Sigma-Aldrich, St. Louis, Mo., USA) was used as the crosslinking agent. All membranes were made with PVA 6-98 unless otherwise specified. A commercial nanofiltration membrane (NF270, Dow Water Solutions, Midland, Mich., USA) was tested as comparison.

PVA powder was dissolved in DI water at 90° C. using mechanical stirring for about 60 minutes to make PVA aqueous solutions. The PVA molecular weight was 47 kDa and the PVA concentration was 0.10 wt %. Next, PVA solutions were cooled to room temperature and the crosslinking agent was added along with 2 M HCl as catalyst under continuous stirring to produce the PVA casting solution. Succinic acid concentration was selected to produce a theoretical crosslinking degree of 20 percent unless otherwise specified. The theoretical crosslinking degree was defined by

$${χ}_{CL} [ \% ] = \frac{{W}_{CL} \times {MW}_{PVAunit} \times 2}{{W}_{PVA} \times {MW}_{CL}} \times 100 ,$$

where W_{CL}, W_{PVA}, MW_{PVAunit}, and MW_{CL} represented the weight of crosslinking agent, the weight of PVA, the molecular weight of one PVA unit (—CHOH—CH₂—), and the molecular weight of the crosslinking agent, respectively.

The polysulfone support membranes were taped onto the glass plate, and only the membrane surface side was contacted with PVA solution in the dip-coating process. Poly(vinyl alcohol) casting solutions were coated onto polysulfone ultrafiltration membranes three times. First, the casting solution was poured onto the PSf support and let sit for 10 minutes. Then, the solute was drained and the remaining water was allowed to evaporate at room temperature over night (24 h). Next, the coated membrane was contacted with the same PVA solution for 10 seconds and air-dried for 24 h again. The 10 seconds coating and drying was repeated to produce defect-free ultra-thin PVA coating layers. The PVA coated polysulfone membranes were then cured at 100° C. for 10 minutes.

The morphology and thickness of the PVA active layers of the composite membranes were characterized with Nova 600 DualBeam™ FIB-SEM (FEI Company, Hillsboro, Oreg.). PVA-PSf composite membrane samples, cross-sectional SEM images were used to estimate PVA film layer thickness. Using the SEM scale bar, we measured the distance between the surface and the top of the first visible pore in the PSf layer at 10 different locations. The slope from the plot of measured water permeability versus measured film thickness provided the thickness independent pure water permeability of each PVA film composition.

The extent of crosslinking of PVA coating layers was confirmed by attenuated total reflection infrared spectroscopy (ATR-IR) performed on a Jasco FTIR 670 plus with variable angle ATR attachment coupled to a germanium crystal operated at a 45 degree. Prior to the ATR-IR measurement, the samples were dried in a desiccator for a minimum of 24 hours. Crystallinity of PVA coating films were observed using X-ray diffraction, XRD (Brüker AXS D8 diffractometer, Germany, using Cu-Kα radiation).

The membrane surface hydrophilicity, surface tensions, and interfacial free energies were determined from measured contact angles using an automated contact angle goniometer (DSA0 KRÜSS GmbH, Hamburg, Germany). At least twelve equilibrium contact angles were measured for each sample. The highest and lowest values were discarded before taking the average and standard deviation. Contact angle measurements for deionized water (polar liquid), diiodomethane (apolar liquid) and glycerol (polar liquid) enabled determination of interfacial tension parameters using the extended Young-Dupre equation.

The separation performance of PVA-PSf composite membranes was evaluated in a bench scale crossflow membrane filtration system equipped with six parallel membrane cells (effective membrane area was 12.9 cm² for each membrane cell). Pure water flux of polysulfone and PVA-PSf membranes were determined using 18 MΩ laboratory de-ionized water at 25° C. and applied pressures of 173 and 1034 kPa (25 and 150 psi), respectively. The crossflow Reynolds number was maintained at 312 without no mesh spacer in the feed channel. Flux was measured by a digital flow meter. Nanofiltration membrane selectivity for NaCl or Na₂SO₄ was characterized by evaluating the conductivity rejection of 2,000 ppm NaCl or Na₂SO₄ solutions individually. Conductivity calibration curves were linear for concentration between 0 and 2,000 ppm of these salts; hence, observed rejections calculated directly from feed and permeate conductivities. All reported flux and rejection data represent the averages of at least three separate tests of membranes hand-cast on three different days using independently prepared PVA coating solutions.

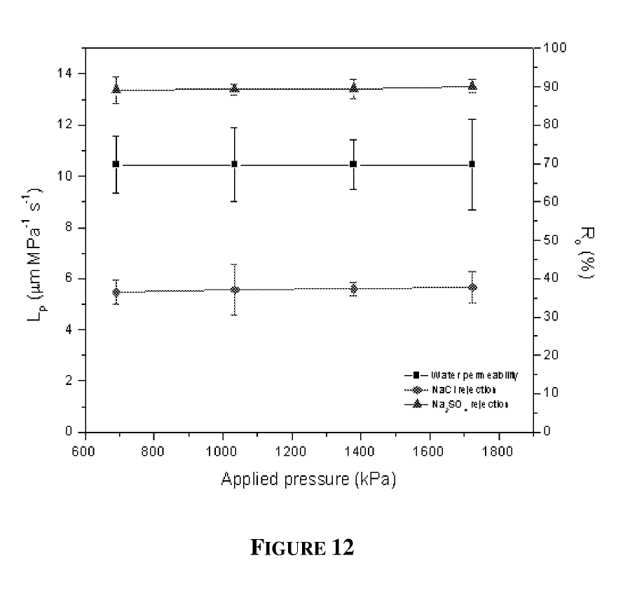

FIG. 12 presents permeability and rejection data for pure water, NaCl and Na₂SO₄ solution with feed pressure through PVA-PSf composite membranes. Pure water flux and solute rejection were measured after the PVA-PSf composite membrane compacted at 1724 kPa (250 psi) for 3 hours. Pure water flux and solute rejection were both relatively stable over the range of applied pressures considered. In principle, flux was proportional to feed pressure and inversely proportional to membrane thickness in membrane (nanofiltration). Any operating condition that produces higher flux increased the observed solute rejection—this is the “dilution effect”. However, the pure water permeability was relatively constant with pressure.

The commercial nanofiltration membrane (Dow NF270) was tested in the cross-flow membrane filtration system. The pure water permeability was 31 μm MPa·s⁻¹ and the rejections of NaCl and Na₂SO₄ were 51 and 94 percent, respectively. For the PVA-PSf composite membrane used to test the effect of pressure, the pure water permeability was only 10.4 μm MPa s⁻¹ with NaCl and Na₂SO₄ rejections of 37.4 and 90.0 percent, respectively. Here the lower flux of the PVA-PSf composite was compensated by the larger differential in NaCl/Na₂SO₄ separation, in addition to the better stability expected for PVA over polyamides.

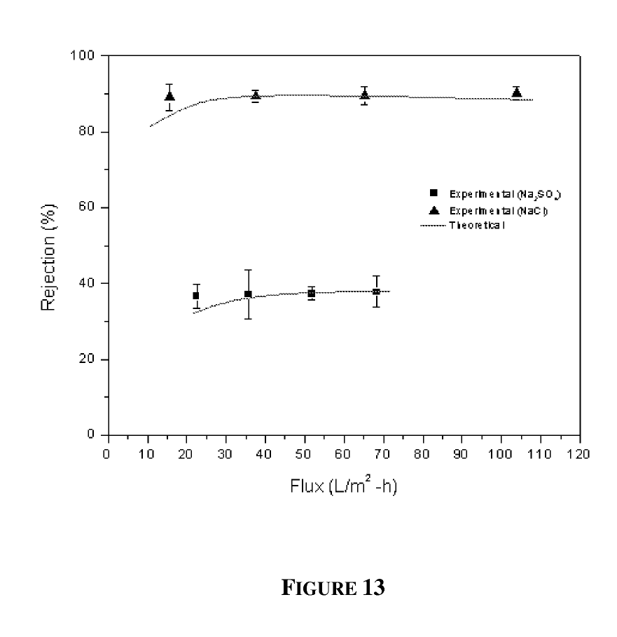

Experimental results from permeation tests described above were used to estimate the membrane transport and mass transfer coefficients. The model-fitted data are shown in FIG. 13. Solute permeability coefficient, reflection coefficient and mass transfer coefficient were different for each solute. Model predictions agreed reasonably well with experimental results.

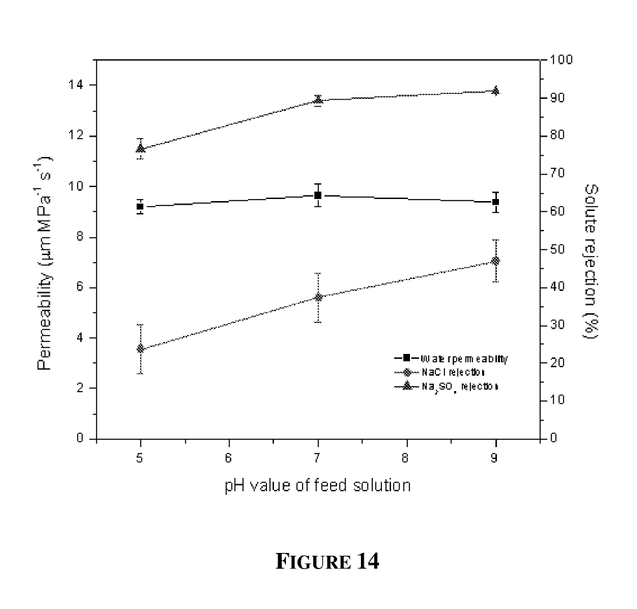

The water flux and salt rejection of PVA-PSf composite NF membranes were investigated for different feed solution pH's (FIG. 14). The pH was adjusted by NaOH addition for all solutions and HCl or H₂SO₄ addition for NaCl and Na₂SO₄ solutions, respectively. The investigated pH values were 5, 7 and 9. Pure water permeability did not change significantly with pH (9.4 μm±0.4 MPa·s⁻¹), but rejection of NaCl and Na₂SO₄ both significantly increased with pH. For example, NaCl rejection increased from 24% (pH 5.0) to 47% (pH 9.0), while Na₂SO₄ rejection increase from 77% (pH 5.0) to 92% (pH 9.0). Here, the increase in rejection was apparently due to greater Donnan exclusion at high pH, rather than structural changes in the film layer.

Incomplete PVA crosslinking reaction with succinic acid leaves some carboxylic residues on the PVA membrane surface. Therefore, at higher pH values PVA membranes were more negatively charged at their surface due to the dissociation of pendent (unreacted) carboxylic acid groups. Therefore, higher rejection occurred at higher pH by Donnan exclusion.

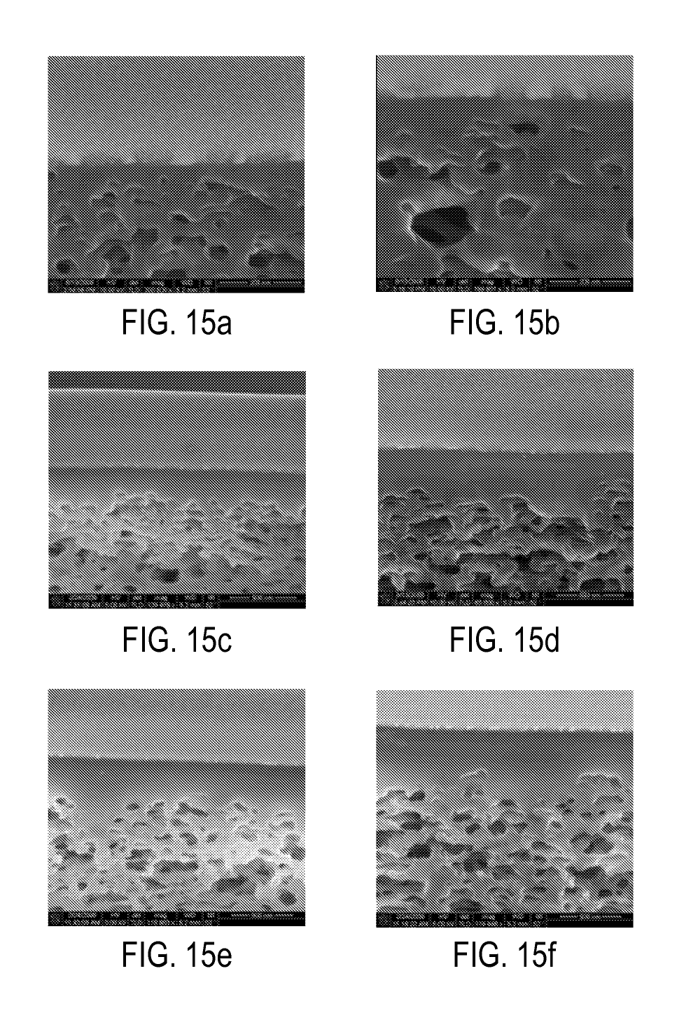

Solutions of 0.05, 0.10, 0.20, 0.30 and 0.50 wt % (PVA powder weight percentage) were used to cast PVA coating films. Representative SEM images of PVA-PSf composite membranes made from different PVA concentrations are shown in FIG. 15. The polysulfone support membrane (FIG. 15a) had a very thin skin layer of about 10-50 nm in thickness between the top surface and the tops of the first visible pores through the cross-section. In fact, these nanopores were also observed at the surface. The PVA layers appeared non-porous, but were hard to discriminate from the polysulfone skin layer showing a good bond was formed between the PSf support and PVA coating film. From the SEM images, the thicknesses of PVA coatings in FIG. 4(b-f) were estimated usually to be about 86±43, 230±28, 320±41, 415±50, 512±67 nm for PVA membranes made from 0.05, 0.10, 0.20, 0.30, 0.50 wt % PVA in the casting solution, respectively.

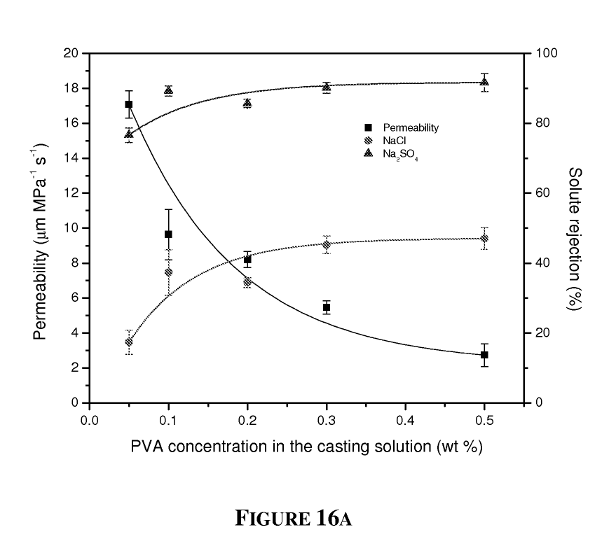

The pure water permeability of PVA-PSf composite membranes decreased, while solute rejection (both sodium chloride and sodium sulfate) increased as PVA solution concentration in the casting solution increased (FIG. 16a). When PVA concentration in the casting solution was higher than 0.10 wt %, the rejection of sodium sulfate was about 90%, but it was below 80% for 0.05 wt % PVA casting solutions. For sodium chloride, the rejection was 35-45% for PVA casting solutions with more than 0.10 wt % PVA, but the rejection was below 20% for 0.05 wt % PVA concentrations in the casting solution. The pure water permeability of the PVA membrane with 0.05 wt % PVA concentration was 17.5 μm MPa s⁻¹, but reduced in proportion to the PVA casting solution concentration.

The film thickness and permeation results produced a correlation between pure water permeability and PVA layer thickness of L_{P}=18.72−0.032×δₘ in PVA-PSf composite membranes (FIG. 5b), where δₘ is the PVA layer thickness in nm. The membrane transport model described above assumed solvent and solute permeability were proportional to a characteristic diffusivity and solubility for each within the polymer phase, and inversely proportional to the polymer film thickness (i.e., P˜DK/δₘ).

The σ and k values determined for the 0.1 wt % PVA film were assumed independent of film thickness. Next, the Pₛ value for 0.1 wt % PVA film was multiplied by the film thickness. This thickness independent permeability was divided by the film thickness determined for each PVA film concentration. Finally, the observed rejection was predicted for each film thickness using σ and k from the 0.1 wt % film, plus δₘ and J_{w} observed during the filtration experiment. In FIG. 16(b), the predicted rejections agree reasonably with observed rejections; hence, these PVA films exhibited selectivity that was inversely dependent on film thickness.

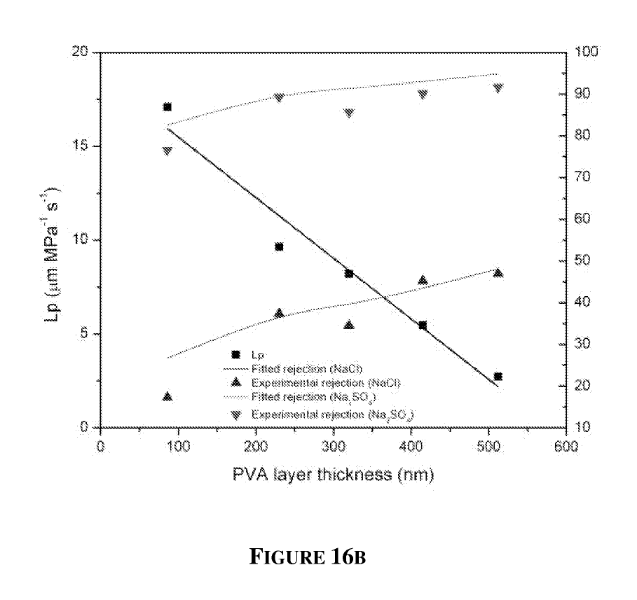

PVA-PSf composite membranes were prepared using PVA with molecular weights of 27, 47, and 61 kDa at 0.10 wt % PVA concentrations in the casting solution. The pure water permeability and solute rejections for PVA-PSf composite membranes are shown in FIG. 17. The 27 kDa PVA composite membranes had the highest pure water permeability of 12.5 μm·MPa⁻¹s⁻¹ and rejections of 13.5% (NaCl) and 60.6% (Na₂SO₄). The membranes made from PVA with molecular weight of 47 kDa showed the highest rejections of 37.5% (NaCl) and 90.5% (Na₂SO₄) with nearly the lowest permeability.

Composite nanofiltration membranes made from different PVA molecular weights exhibited different contact angles, and wettability and hydrophilicity as shown in Table 2. The contact angle of DI water for the polysulfone support membrane was about 74°, but the contact angles of DI water for all PVA composite membranes were between 25°-32°. The solid-liquid interfacial free energy (−ΔG₁₃) calculated from the measured contact angles and known liquid surface tension of water is a more fundamental property for describing the wettability of solid surfaces. Typically, a condensed-phase material is considered “wetting” if −ΔG₁₃>72.8 mJ/m², which corresponds to a contact of 90° for pure water at 20° C. Lower molecular weight PVA produced slightly more hydrophilic surfaces.

The LW and AB components of surface tension both increased with PVA molecular weight. The higher total surface tension made wetting less favorable, while the increased electron acceptor functionality enhanced PVA self-attraction (i.e., decreased hydrophilicity). As shown in Table 2, AG₁₃₁ followed the same trend.

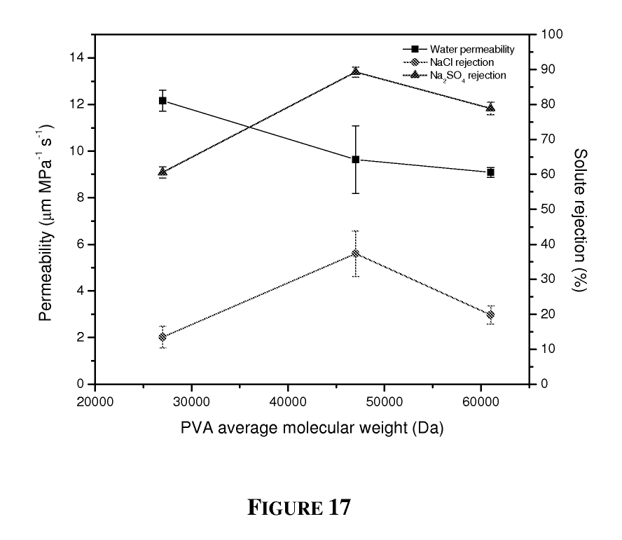

The functionality responsible for the wettability and hydrophilicity of PVA was elucidated by ATR-IR spectroscopy. In FIG. 18, the absorbance at 3,000-3,600 cm⁻¹ represents the —OH stretch associated with —OH groups in the PVA polymer chain and pendent —COOH groups from incomplete crosslinking reaction. The membrane made from PVA with molecular weight of 47 kDa showed strongest peaks at 3000-3600 cm⁻¹.

The peaks at 1630-1760 cm⁻¹ were the —C═O— in —C═O—O—C—, which reflect the extent of crosslinking. As shown in FIG. 18, films made from PVA with molecular weight of 27 kDa showed the highest peak at both wavenumbers, films made from 61 kDa PVA showed the lowest peaks. The actual extent of crosslinking was highest for PVA coating films made from 27 kDa polymer even though theoretical crosslinking degrees were designed to be the same (20%).

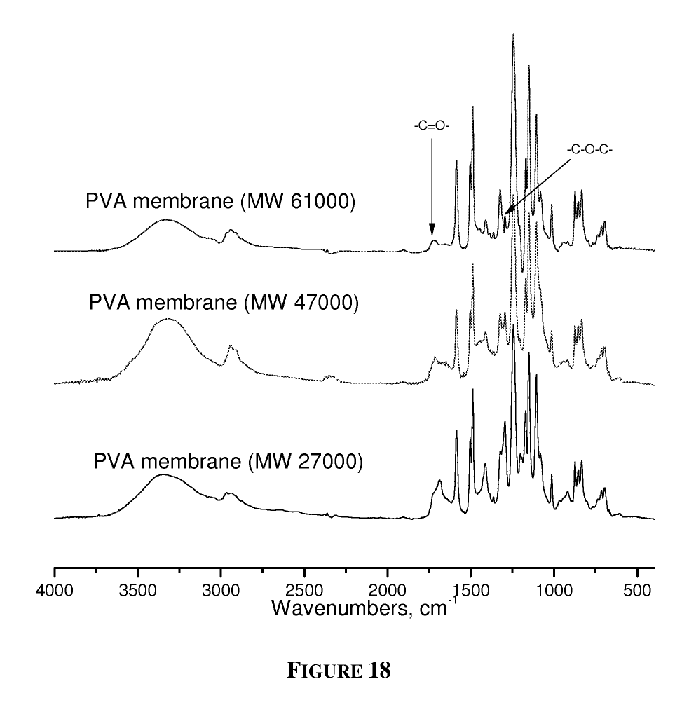

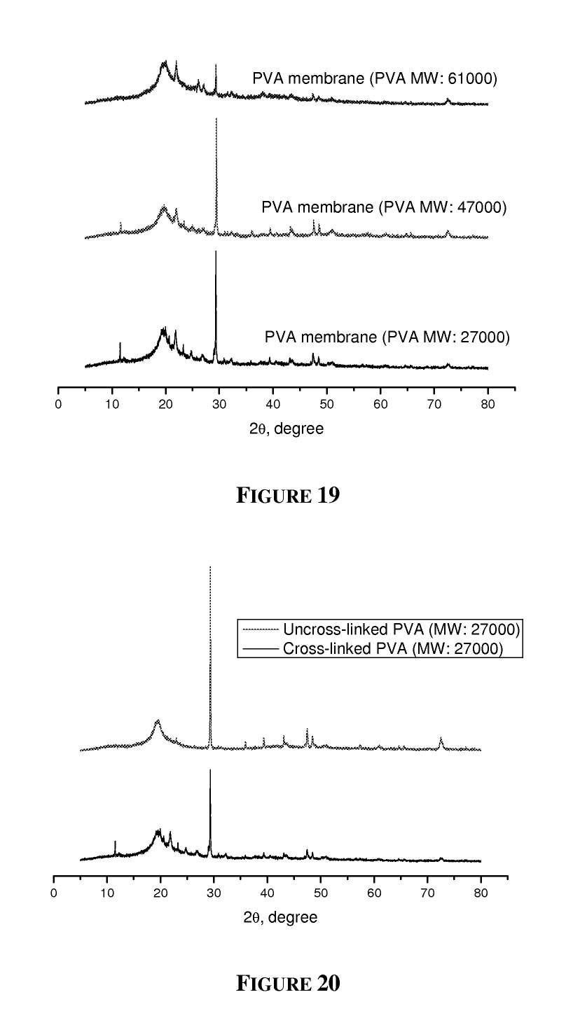

The extent of crosslinking controlled the crystallinity of PVA films, which impacts permeability and selectivity. The crystalline properties of PVA films are described by XRD results in FIG. 19. Composite membranes made from PVA with molecular weight of 27,000 exhibited the highest extent of crosslinking based on FTIR results. The higher extent of crosslinking of PVA destroyed more crystalline areas of the PVA films, which resulted in looser polymer chain packing or aggregate structure. As shown in FIG. 20, the 27 kDa cross-linked PVA had lower crystallinity (11.6%) than uncrosslinked PVA (15.4%). The XRD results confirmed that the crystallinity of PVA films increased with increasing PVA molecular weight. The degrees of crystallinity were 11.6, 15.2 and 15.9 percent for PVA with molecular weight of 27, 47, and 61 kDa respectively. Thus, PVA composite membrane permeability decreased with increasing PVA molecular weight.

### F. REFERENCES

(1) Bolto, B.; Tran, T.; Hoang, M. Xie, Z. L. Prog. Polym. Sci. 2009, 34 (9), 969-981.
(2) Petersen, R. J. J. Membr. Sci. 1993, 83, 81-150.
(3) Dai, W. S. Barbari, T. A. J. Membr. Sci. 1999, 156 (1), 67-79.
(4) Ma, X.; Su, Y.; Sun, Q.; Wang, Y. Jiang, Z. J. Membr. Sci. 2007, 300 (1-2), 71-78.
(5) Wang, Y. L.; Yang, H. Xu, Z. L. J. Appl. Polym. Sci. 2008, 107 (3), 1423-1429.
(6) Myung, S. W.; Choi, I. H.; Lee, S. H.; Kim, I. C. Lee, K. H. Water Sci. Technol. 2005, 51 (6-7), 159-164.
(7) Bezuidenhout, D.; Hurndall, M. J.; Sanderson, R. D. van Reenen, A. J. Desalin. 1998, 116 (1), 35-43.
(8) Lang, K.; Sourirajan, S.; Matsuura, T. Chowdhury, G. Desalin. 1996, 104 (3), 185-196.
(9) Lang, K.; Matsuura, T.; Chowdhury, G. Sourirajan, S. Can. J. Chem. Eng. 1995, 73 (5), 686-692.
(10) Jegal, J.; Oh, N. W.; Park, D. S. Lee, K. H. J. Appl. Polym. Sci. 2001, 79 (13), 2471-2479.
(11) Peng, F. B.; Lu, L. Y.; Sun, H. L.; Wang, Y. Q.; Liu, J. Q. Jiang, Z. Y. Chem. Mat. 2005, 17 (26), 6790-6796.
(12) Peng, F. B.; Lu, L. Y.; Hu, C. L.; Wu, H. Jiang, Z. Y. J. Membr. Sci. 2005, 259 (1-2), 65-73.
(13) Yang, M. H. Polymer Testing 1995, 14, 415-424.
(14) Lang, K.; Chowdhury, G.; Matsuura, T. Sourirajan, S. J. Colloid Interface Sci. 1994, 166, 239-244.
(15) Immelman, E.; Sanderson, R. D.; Jacobs, E. P. Vanreenen, A. J. J. Appl. Polym. Sci. 1993, 50 (6), 1013-1034.
(16) Immelman, E.; Sanderson, R. D.; Jacobs, E. P. Vanreenen, A. J. Desalin. 1993, 94 (1), 37-54.
(17) Sanderson, R. D.; Immelman, E.; Bezuidenhout, D.; Jacobs, E. P. Vanreenen, A. J. Desalin. 1993, 90 (1-3), 15-29.
(18) Chu, T. J. Yang, M. H. J. Chem. Eng. Japan 1992, 25, 660-665.
(19) Jegal, J.; Oh, N. W. Lee, K. H. J. Appl. Polym. Sci. 2000, 77 (2), 347-354.
(20) Jegal, J. Lee, K. H. J. Appl. Polym. Sci. 1999, 72 (13), 1755-1762.
(21) Pan, F. S.; Peng, F. B. Jiang, Z. Y. Chem. Eng. Sci. 2007, 62 (3), 703-710.
(22) Sun, H. J. Phy. Chem. B 1998, 102, 7338-7364.
(23) Peng, F. B.; Huang, X. F.; Jawor, A. Hoek, E. M. V. J. Membr. Sci. Accepted doi:10.1016/j.memsci.2010.02.044.
(24) Pan, F. S.; Peng, F. B.; Lu, L. Y.; Wang, J. T. Jiang, Z. Y. Chem. Eng. Sci. 2008, 63 (4), 1072-1080.
(25) Peng, F. B.; Pan, F. S.; Sun, H. L.; Lu, L. Y. Jiang, Z. Y. J. Membr. Sci. 2007, 300, 13-19.
(26) Brant, J. A. Childress, A. E. J. Membr. Sci. 2002, 203, 257-273.
(27) Jin, X. Hoek, E. M. V. Environ. Sci. Technol. 2009, 43, 3580-3587.
(28) Subramani, A.; Huang, X. F. Hoek, E. M. V. J. Colloid Interface Sci. 2009, 336 (1), 13-20.
(29) Fujita, H. Fortschr. Hochpolym. Forsch. 1961, 3, 1.
(30) Aitken, C. L.; Koros, W. J. Paul, D. R. Macromolecules 1992, 25, 3424.
(31) Nagel, C.; Anther-Schade, G.; Fritsch, K. D.; Strunskus, T. Faupel, F. Macromolecules 2002, 35, 2071.
(32) Pixton, M. R. Paul, D. R. Polym. Testing 1995, 36, 2745.
(33) Mondal, S. et. al. Produced water treatment by nanofiltration and reverse osmosis membranes. Journal of Membrane Science. 322 (2008), 162-170.
(34) Asatekin A., et. al. Oil Industry Wastewater Treatment with Fouling Resistant Membranes Containing Amphiphilic Comb Copolymers. Environ. Sci. Technol. 2009, 43, 4487-4492.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An oil-tolerant water-filtration membrane comprising a microporous hydrogel coated on at least one side of a porous polymeric support membrane.

2. The membrane of claim 1, wherein the porous polymeric support membrane is a polysulfone ultrafiltration membrane.

3. The membrane of claim 2, wherein the microporous hydrogel coating is a crosslinked polyvinyl alcohol film.

4. The membrane of claim 3, wherein the polyvinyl alcohol film has a crosslinking degree of from about 10 percent to about 80 percent.

5. The membrane of claim 3, wherein the polyvinyl alcohol film is crosslinked with succinic acid, maleic acid, malic acid, glutaraldehyde, or suberic acid.

6. The membrane of claim 5, wherein the polyvinyl alcohol film has a crosslinking degree of about 10 percent to about 80 percent.

7. The membrane of claim 1, wherein the membrane has a water contact angle of less than about 40°.

8. The membrane of claim 1, wherein the hydrogel coating has a thickness sufficient to provide oil rejection of at least about 95% and a normalized flux of at least about 1.

9. The membrane of claim 1, wherein the membrane has a free energy of cohesion greater than zero.

10. A method for preparing an oil-tolerant water-filtration membrane comprising applying a microporous hydrogel coating to at least one side of a porous polymeric support membrane.

11. The membrane of claim 10, wherein the polymeric membrane is a polysulfone membrane.

12. The method of claim 11, wherein the microporous hydrogel is a polyvinyl alcohol film.

13. A method for purifying water comprising:
(a) providing a water-filtration membrane comprising a microporous hydrogel coated on a polymeric support membrane, the water-filtration membrane having a first face corresponding to a thin film discrimination layer and a second face corresponding to the porous support;
(b) applying pressure to a water solution, having at least one solute, at the first face of the water-filtration membrane; and
(c) collecting purified water at the second face of water-filtration membrane.

14. The method of claim 13, wherein the polymeric support membrane is a polysulfone membrane.

15. The method of claim 13, wherein the microporous hydrogel coating is a hydrophilic crosslinked polymeric film comprising polyvinyl alcohol.
